(19) United States
(12) Patent Application Publication
(10) Pub. No.: US 2023/0258613 A1
(43) Pub. Date: Aug. 17, 2023

(54) ACOUSTIC DIAGNOSTIC APPARATUS, ACOUSTIC DIAGNOSTIC METHOD, AND NON-TRANSITORY COMPUTER-READABLE STORAGE MEDIUM RECORDING ACOUSTIC DIAGNOSTIC PROGRAM

(71) Applicant: KABUSHIKI KAISHA TOSHIBA, Tokyo (JP)

(72) Inventors: Tatsuhiko GOTO, Kawasaki (JP); Akihiko ENAMITO, Kawasaki (JP); Osamu NISHIMURA, Kawasaki (JP)

(73) Assignee: KABUSHIKI KAISHA TOSHIBA, Tokyo (JP)

(21) Appl. No.: 17/823,565

(22) Filed: Aug. 31, 2022

(30) Foreign Application Priority Data
Feb. 14, 2022 (JP) 2022-020728

(51) Int. Cl. G01N 29/46; G01N 29/12; G01N 29/44

(52) U.S. Cl. CPC G01N 29/46; G01N 29/12; G01N 29/4427; G01N 2291/0289; G01N 2291/104; G01N 2291/105; G01N 29/223

(57) ABSTRACT

According to one embodiment, an acoustic diagnostic apparatus includes an acoustic vibration unit, an acoustic vibration signal generation unit, a sound receiving unit, an impulse response calculation unit, an analysis unit, and a diagnostic unit. The vibration unit applies an acoustic vibration to a diagnosis target. The signal generation unit continuously inputs an acoustic vibration signal to the vibration unit. The receiving unit receives an evaluation target sound from the target, and output a sound reception signal. The calculation unit calculates an impulse response based on the sound reception signal. The analysis unit calculates an acoustic characteristic using the impulse response, and analyzes a state of the target. The diagnostic unit diagnoses the state of the target based on an analysis result of the analysis unit.

### CROSS-REFERENCE TO RELATED APPLICATIONS

This application is based upon and claims the benefit of priority from Japanese Patent Application No. 2022-020728, filed Feb. 14, 2022; the entire contents of which are incorporated herein by reference.

### FIELD

Embodiments described herein relate generally to an acoustic diagnostic apparatus, an acoustic diagnostic method, and an acoustic diagnostic program.

### BACKGROUND

In a building or infrastructure, a change in rigidity caused by a change in welding and joining conditions of the structure, a change in structure damping characteristic caused by peeling of an internal coating material such as a damping material, or a change in strength caused by rust, a crack, or hollowing of an internal structure may occur as deterioration over time. Conventionally, periodic deterioration evaluation is performed by hammering or the like.

### BRIEF DESCRIPTION OF THE DRAWINGS

FIG. 1 is a block diagram of an acoustic diagnostic apparatus according to an embodiment.

FIG. 2 is a block diagram showing the hardware of a diagnostic processing unit shown in FIG. 1.

FIG. 3 is a view schematically showing four arrangement examples of an acoustic vibration unit.

FIG. 4 is a view schematically showing five arrangement examples of a single microphone applied to each of the microphones of a sound receiving unit.

FIG. 5 is a view schematically showing two arrangement examples of the first and second microphones.

FIG. 6 is a view schematically showing two arrangement examples of the sound receiving unit.

FIG. 7 is a flowchart illustrating the procedure of diagnostic processing executed by the diagnostic processing unit.

FIG. 8 is a flowchart illustrating the processing procedure of single microphone frequency characteristic evaluation 1.

FIG. 9 is a flowchart illustrating the processing procedure of single microphone frequency characteristic evaluation 2.

FIG. 10 is a flowchart illustrating the processing procedure of two-microphone intensity evaluation 1.

FIG. 11 is a flowchart illustrating the processing procedure of two-microphone intensity evaluation 2.

FIG. 12 is a flowchart illustrating the processing procedure of auxiliary structure state analysis.

FIG. 13 is a timing chart showing a Logss signal based on equation (3) set with predetermined values.

FIG. 14 is a timing chart showing a Logss signal obtained by shifting the signal shown in FIG. 13 by a predetermined value.

FIG. 15 is a timing chart showing the spectrogram of the Logss signal after the shift shown in FIG. 14.

FIG. 16 is a timing chart showing the relationship between the frequency and the time in the spectrogram of the Logss signal given by equations (6) to (8).

FIG. 17 is a timing chart showing a spectrogram when a harmonic distortion occurs in the Logss signal with the spectrogram shown in FIG. 16.

FIG. 18 is a timing chart showing impulse responses each obtained by converting, based on the inverse characteristic of the Logss signal, the response curve of the Logss signal with the spectrogram shown in FIG. 17.

FIG. 19 is a graph showing a result of calculating, based on equation (9), the occurrence times of the distortion characteristics shown in FIG. 18.

FIG. 20 is a graph showing a result of calculating, based on equation (10), the occurrence times of the distortion characteristics shown in FIG. 18 in the impulse responses.

FIG. 21 is a timing chart showing an example of an impulse response.

FIG. 22 is an enlarged view of a region Rb corresponding to the nonlinear characteristic of the impulse response.

FIG. 23 is a graph of an example of measurement of active intensity.

FIG. 24 is a graph of an example of measurement of reactive intensity.

FIG. 25 is a view schematically showing one microphone and a diagnosis target object in a reference state.

FIG. 26 is a view schematically showing a state in which the sound absorption characteristic of the diagnosis target object deteriorates, as compared with the reference state shown in FIG. 25.

FIG. 27 is a view schematically showing a state in which a small vibration of the diagnosis target object increases, as compared with the reference state shown in FIG. 25.

FIG. 28 is a view schematically showing the two microphones and the diagnosis target object in a reference state.

FIG. 29 is a view schematically showing a state in which the sound absorption characteristic of the diagnosis target object increases, as compared with the reference state shown in FIG. 28.

FIG. 30 is a view schematically showing a state in which a small vibration of the diagnosis target object decreases, as compared with the reference state shown in FIG. 28.

FIG. 31 is a view schematically showing the state of movement of the center of a speaker and display of the contour lines of the measurement result.

FIG. 32 is a graph showing measurement analysis data and the baseline of the ratio of the active intensity.

FIG. 33 is a view schematically showing a state in which a small vibration of a diagnosis target object increases after peeling of a damping material, as compared with a state before peeling of the damping material.

FIG. 34 is a view schematically showing a state in which the sound absorption characteristic of the diagnosis target object increases after peeling of the damping material, as compared with a state before peeling of the damping material.

FIG. 35 is a view showing the arrangement relationship among the speaker, the microphones, and the diagnosis target object in an example of diagnosis of peeling of the damping material.

FIG. 36 is a view showing damping materials adhered to the bottom plate of a steel can.

FIG. 37 is a graph showing the results of LDV measurement in a wavelength range of 200 to 900 Hz.

FIG. 38 is a graph showing differences between the results of LDV measurement in a frequency band of 200 to 900 Hz.

FIG. 39 is a graph showing the results of LDV measurement in a frequency band of 1,500 to 4,000 Hz.

FIG. 40 is a graph showing differences between the results of LDV measurement in a frequency band of 1,500 to 4,000 Hz.

FIG. 41 is a graph showing the evaluation result of a difference transfer characteristic by single microphone frequency characteristic evaluation 1 with respect to a linear characteristic in 1 KHz or less.

FIG. 42 is a graph showing the evaluation result of a response difference transfer characteristic by single microphone frequency characteristic evaluation 2 with respect to the linear characteristic in 1 KHz or less.

FIG. 43 is a graph showing the evaluation result of the active intensity by two-microphone intensity evaluation 1 in a wavelength range of 320 to 500 Hz with respect to the linear characteristic in 1 KHz or less.

FIG. 44 is a graph showing the evaluation result of the active intensity by two-microphone intensity evaluation 1 in a wavelength range of 600 to 750 Hz with respect to the linear characteristic in 1 KHz or less.

FIG. 45 is a graph showing the evaluation result of differences in active intensity by two-microphone intensity evaluation 1 with respect to the linear characteristic in 1 KHz or less.

FIG. 46 is a graph showing the evaluation result of the ratios of the active intensity by two-microphone intensity evaluation 1 with respect to the linear characteristic in 1 KHz or less.

FIG. 47 is a graph showing the evaluation result of response differential active intensities by two-microphone intensity evaluation 2 with respect to the linear characteristic in 1 KHz or less.

FIG. 48 is a graph showing the evaluation result of differences in active intensity by two-microphone intensity evaluation 1 with respect to the linear characteristic in 1 KHz or less.

FIG. 49 is a graph showing the evaluation result of the ratios of the active intensity by two-microphone intensity evaluation 1 with respect to the linear characteristic in 1 KHz or less.

FIG. 50 is a graph showing the evaluation result of a difference transfer characteristic by single microphone frequency characteristic evaluation 1 in auxiliary structure state analysis.

FIG. 51 is a graph showing the evaluation result of the ratios of the active intensity by two-microphone intensity evaluation 1 in auxiliary structure state analysis.

FIG. 52 is a graph showing the evaluation result of differences in active intensity by two-microphone intensity evaluation 1.

FIG. 53 is a graph showing the evaluation result of differences in reactive intensity by two-microphone intensity evaluation 1.

FIG. 54 is a graph showing the evaluation result of the ratios of the active intensity at a sound pressure ratio of 6 dB/3 dB by two-microphone intensity evaluation 1 in auxiliary structure state analysis.

FIG. 55 is a graph showing the evaluation result of the ratios of the active intensity at a sound pressure ratio of 9 dB/3 dB by two-microphone intensity evaluation 1 in auxiliary structure state analysis.

FIG. 56 is a view showing the arrangement relationship among the speaker, the microphones, and the diagnosis target object.

FIG. 57 is a flowchart illustrating the processing procedure of diagnostic processing based on another analysis method different from that shown in FIGS. 8, 9, 10, and 11.

FIG. 58 is a graph showing the evaluation result of a transfer characteristic in a frequency band of 1 KHz or less.

FIG. 59 is a graph showing the evaluation result of a difference transfer characteristic in a frequency band of 1 KHz or less.

FIG. 60 is a graph showing the evaluation result of a transfer characteristic in a frequency band of 1 KHz or more.

FIG. 61 is a graph showing the evaluation result of a difference transfer characteristics in a frequency band of 1 KHz or more.

FIG. 62 is a graph showing the evaluation result of active intensity in a frequency band of 1 KHz or less.

FIG. 63 is a graph showing the evaluation result of differences in active intensity in a frequency band of 1 KHz or less.

FIG. 64 is a graph showing the evaluation result of the active intensity in a frequency band of 1 KHz or more.

FIG. 65 is a graph showing the evaluation result of the differences in active intensity in a frequency band of 1 KHz or more.

FIG. 66 is a graph showing the evaluation result of a sound absorption coefficient in a frequency band of 1 KHz or less.

FIG. 67 is a graph showing the evaluation result of differences in the sound absorption coefficient in a frequency band of 1 KHz or less.

FIG. 68 is a graph showing the evaluation result of the sound absorption coefficient in a frequency band of 1 KHz or more.

FIG. 69 is a graph showing the evaluation result of differences in the sound absorption coefficient in a frequency band of 1 KHz or more.

### DETAILED DESCRIPTION

According to one embodiment, an acoustic diagnostic apparatus includes an acoustic vibration unit, an acoustic vibration signal generation unit, a sound receiving unit, an impulse response calculation unit, a structure state analysis unit, and a structure state diagnostic unit. The acoustic vibration unit is configured to apply an acoustic vibration to a diagnosis target object. The acoustic vibration signal generation unit is configured to generate an acoustic vibration signal and continuously input the acoustic vibration signal to the acoustic vibration unit. The sound receiving unit is configured to receive an evaluation target sound including a sound wave reflected from the diagnosis target object and a vibration radiated sound from the diagnosis target object, and output a sound reception signal. The impulse response calculation unit is configured to calculate an impulse response based on the sound reception signal. The structure state analysis unit is configured to calculate an acoustic characteristic using the impulse response, and analyze a state of the diagnosis target object by grasping a change of the sound reception signal. The structure state diagnostic unit is configured to diagnose the state of the diagnosis target object based on an analysis result of the structure state analysis unit.

According to one embodiment, an acoustic diagnostic method includes: applying an acoustic vibration to a diagnosis target object by continuously inputting an acoustic vibration signal to an acoustic vibration unit; calculating an impulse response based on a sound reception signal output from a sound receiving unit configured to receive an evaluation target sound including a sound wave reflected from the diagnosis target object and a vibration radiated sound from the diagnosis target object; calculating an acoustic characteristic using the impulse response, and analyzing a state of the diagnosis target object by grasping a change of the sound reception signal; and diagnosing the state of the diagnosis target object based on an analysis result.

According to one embodiment, a non-transitory computer-readable storage medium stores an acoustic diagnostic program for causing a computer, including a processor and a storage device, to execute functions of the acoustic vibration signal generation unit, the impulse response calculation unit, the structure state analysis unit, and the structure state diagnostic unit of the acoustic diagnostic apparatus.

An embodiment will be described below with reference to the accompanying drawings.

(Functional Arrangement)

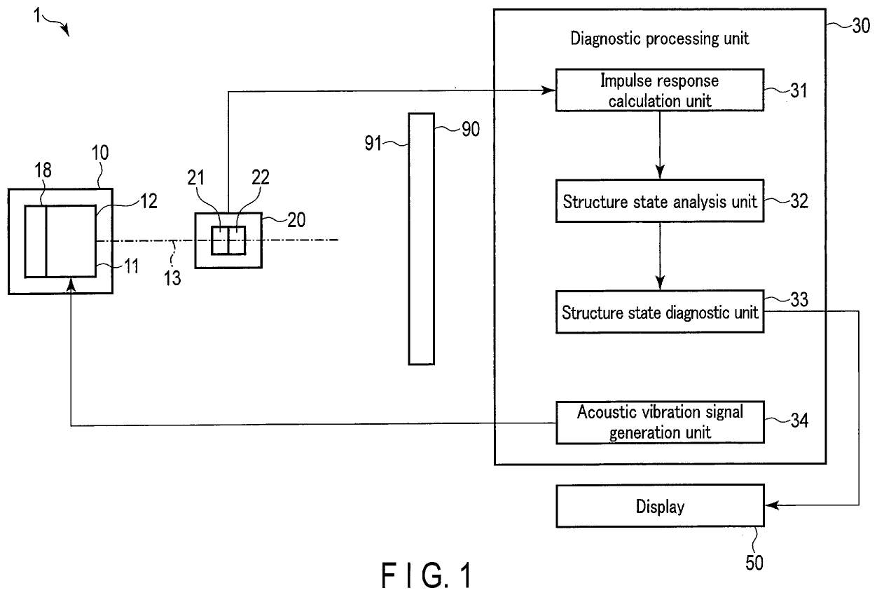

The functional arrangement of an acoustic diagnostic apparatus according to the embodiment will first be described with reference to FIG. 1. FIG. 1 is a block diagram showing an example of the functional arrangement of an acoustic diagnostic apparatus 1 according to the embodiment. The acoustic diagnostic apparatus 1 is an apparatus that diagnoses a diagnosis target object 90 using a sound wave.

The acoustic diagnostic apparatus 1 includes an acoustic vibration unit 10, a sound receiving unit 20, a diagnostic processing unit 30, and a display 50.

The acoustic vibration unit 10 applies an acoustic vibration to the diagnosis target object 90. Applying an acoustic vibration to the diagnosis target object 90 indicates emitting a sound wave to the diagnosis target object 90 and applying a vibration to the diagnosis target object 90. For example, the acoustic vibration unit 10 includes one or more speakers 11. The speaker 11 emits a sound wave for an acoustic vibration to the diagnosis target object 90.

The speaker 11 emits a sound wave forward from a front 12. The speaker 11 is arranged so that the front 12 faces the diagnosis target object 90. The diagnosis target object 90 includes a plane 91. The speaker 11 is arranged so that the front 12 of the speaker 11 is parallel to the plane 91 of the diagnosis target object 90. An axis passing through the center of the sound source of the speaker 11 and perpendicular to the front 12 of the speaker 11 will be referred to as a speaker axis 13 hereinafter. A direction away from the speaker 11 on the speaker axis 13 will be referred to as the emission direction of the sound wave for an acoustic vibration.

The acoustic vibration unit 10 may have a moving mechanism 18 for moving the speaker 11 on a plane perpendicular to the speaker axis 13.

The sound receiving unit 20 includes two or more microphones. For example, the sound receiving unit 20 includes a first microphone 21 and a second microphone 22. Each of the microphones 21 and 22 receives the sound wave, and outputs an electrical sound reception signal that reflects a sound pressure. The sound wave received by each of the microphones 21 and 22 includes an evaluation target sound including a sound wave reflected from the diagnosis target object 90 and a vibration radiated sound from the diagnosis target object 90, a radiated sound from the speaker 11, and an ambient reflected sound.

The diagnostic processing unit 30 drives the speaker 11, and also diagnoses the diagnosis target object 90 based on the sound reception signals of the microphones 21 and 22.

The display 50 displays a diagnosis result by the diagnostic processing unit 30.

The diagnostic processing unit 30 includes an impulse response calculation unit 31, a structure state analysis unit 32, a structure state diagnostic unit 33, and an acoustic vibration signal generation unit 34.

The impulse response calculation unit 31 calculates the impulse responses of the first microphone 21 and the second microphone 22 based on the sound reception signals of the first microphone 21 and the second microphone 22, respectively.

The structure state analysis unit 32 calculates an acoustic characteristic using the impulse responses of the first microphone 21 and the second microphone 22, thereby analyzing the state of the diagnosis target object 90.

The structure state diagnostic unit 33 evaluates the acoustic characteristic based on the analysis result of the structure state analysis unit 32, thereby diagnosing the state of the diagnosis target object 90.

The acoustic vibration signal generation unit 34 generates an acoustic vibration signal for causing the speaker 11 to emit a sound wave for an acoustic vibration, and continuously inputs the acoustic vibration signal to the speaker 11. In response to the input of the acoustic vibration signal, the speaker 11 emits a sound wave for an acoustic vibration. The acoustic vibration signal is a TSP (Time Stretched Pulse) signal. For example, the acoustic vibration signal is a Logss (Log Swept Sine) signal, which is a kind of TSP signal and capable of separating a nonlinear characteristic. If the Logss signal is used, it is possible to monitor not only the linear characteristic but also a change in nonlinear characteristic.

The acoustic diagnostic apparatus 1 applies an acoustic vibration to the diagnosis target object 90 by the acoustic vibration unit 10, measures the vibration of the diagnosis target object 90 using the sound receiving unit 20, and evaluates the acoustic characteristic. However, the embodiment is not limited to this. If it is possible to measure the vibration of the diagnosis target object 90 using a laser Doppler vibrometer (LDV), LDV measurement may be performed. In evaluation of the acoustic characteristic, a change in the state of the rear surface of the diagnosis target object 90 that cannot be measured by the LDV can be evaluated based on intensity correlated with a sound absorption coefficient or the sound absorption coefficient.

(Hardware Arrangement)

The hardware arrangement of the diagnostic processing unit 30 will be described next. The diagnostic processing unit 30 is formed by a computer. For example, the diagnostic processing unit 30 is formed by a personal computer, a server computer, or the like.

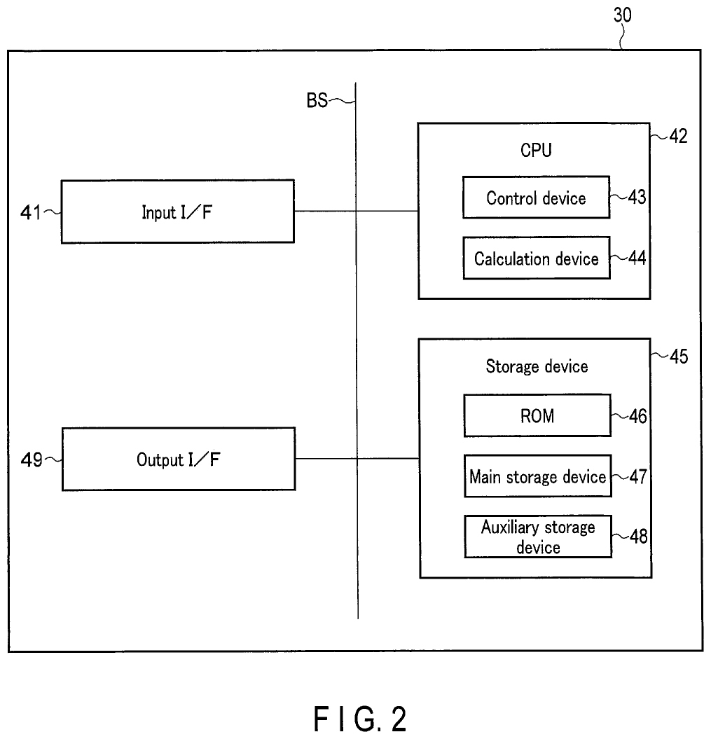

FIG. 2 is a block diagram showing an example of the hardware arrangement of the diagnostic processing unit 30 according to the embodiment. As shown in FIG. 2, the diagnostic processing unit 30 includes an input I/F 41, a CPU 42, a storage device 45, and an output I/F 49. The diagnostic processing unit may additionally include another peripheral device.

The input I/F 41, the CPU 42, the storage device 45, and the output I/F 49 are electrically connected via a bus BS, and exchange data and commands via the bus BS.

The input I/F 41 is a device that receives a signal from the outside, converts the signal into data, and transfers the data to the CPU 42 and the storage device 45.

The output I/F 49 is a device that receives data from the CPU 42 and the storage device 45, converts the data into signals, and outputs the signals.

The storage device 45 stores programs and data necessary for processing executed by the CPU 42. The CPU 42 performs various processes by reading out the necessary programs and data from the storage device 45 and executing them.

The storage device 45 includes a ROM 46, a main storage device 47, and an auxiliary storage device 48. The main storage device 47 and the auxiliary storage device 48 exchange programs and data.

The ROM 46 stores a program (BIOS) for controlling the CPU 42 at the time of activation.

The main storage device 47 stores the programs and data temporarily necessary for the processing of the CPU 42. For example, the main storage device 47 is formed by a volatile memory such as a RAM (Random Access Memory).

The auxiliary storage device 48 stores programs and data supplied via an external device or a network, and provides the programs and data temporarily necessary for the processing of the CPU 42 to the main storage device 47. For example, the auxiliary storage device 48 is formed by a nonvolatile memory such as an HDD (Hard Disk Drive) or an SSD (Solid State Drive).

The CPU 42 is a processor and is hardware for processing data and commands. The CPU 42 includes a control device 43 and a calculation device 44.

The control device 43 controls the input I/F 41, the calculation device 44, the storage device 45, and the output I/F 49.

The calculation device 44 loads the programs and data from the main storage device 47, executes the programs to process data, and provides the processed data to the main storage device 47.

In this hardware arrangement, the CPU 42 and the storage device 45 form the respective units of the diagnostic processing unit 30, that is, the impulse response calculation unit 31, the structure state analysis unit 32, the structure state diagnostic unit 33, and the acoustic vibration signal generation unit 34.

For example, the CPU 42 loads the program for executing the function of the diagnostic processing unit 30 from the auxiliary storage device 48 into the main storage device 47, and executes the loaded program, thereby performing the operation of the diagnostic processing unit 30. The program is stored in a non-transitory computer-readable storage medium. That is, the auxiliary storage device 48 includes the non-transitory computer-readable storage medium storing the program.

(Acoustic Vibration Unit 10)

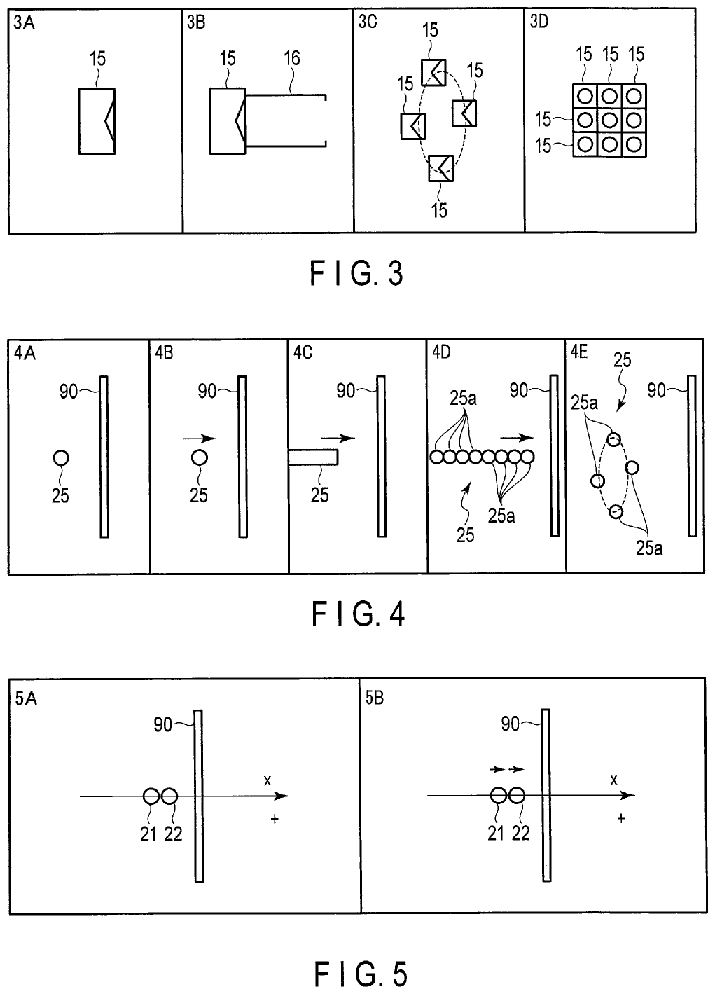

An example of the arrangement of the acoustic vibration unit 10 will be described next with reference to FIG. 3. FIG. 3 is a view schematically showing four arrangement examples 3A, 3B, 3C, and 3D of the acoustic vibration unit 10. In the arrangement example 3A, the acoustic vibration unit 10 includes a single speaker 15. In the arrangement example 3B, the acoustic vibration unit 10 includes a directional single sound source having directivity improved by attaching an acoustic cylinder 16 to the single speaker 15. In the arrangement example 3C, the acoustic vibration unit 10 includes a speaker group in which a plurality of single speakers 15 are arranged on a circumference to be in-phase driven. In the arrangement example 3D, the acoustic vibration unit 10 includes a speaker group in which a plurality of single speakers are arranged on a grid to simulatively output plane waves. Alternatively, the acoustic vibration unit 10 may include a general-purpose flat speaker.

(Sound Receiving Unit 20)

As described above, the sound receiving unit 20 includes two or more microphones. An example of the arrangement of each microphone will now be described with reference to FIG. 4. FIG. 4 is a view schematically showing five arrangement examples 4A, 4B, 4C, 4D, and 4E of a single microphone 25 applied to each of the microphones 21 and 22. In the arrangement example 4A, the single microphone 25 is a nondirectional microphone. In the arrangement example 4B, the single microphone 25 is a directional microphone. In the arrangement example 4C, the single microphone 25 is a shotgun microphone and has very high directivity. In the arrangement example 4D, the single microphone 25 is a line array microphone. The line array microphone includes a plurality of microphones 25a but outputs a delay-and-sum output, and can thus be regarded as a single microphone. In the arrangement example 4E, the single microphone 25 is a circular array microphone. The circular array microphone includes a plurality of microphones 25a but outputs a sum output, and can thus be regarded as a single microphone.

An example of the arrangement of the first microphone 21 and the second microphone 22 of the sound receiving unit 20 will be described next with reference to FIG. 5. FIG. 5 is a view schematically showing two arrangement examples 5A and 5B of the first microphone 21 and the second microphone 22. In the arrangement example 5A, both the first microphone 21 and the second microphone 22 are nondirectional microphones. In the arrangement example 5B, both the first microphone 21 and the second microphone 22 are directional microphones.

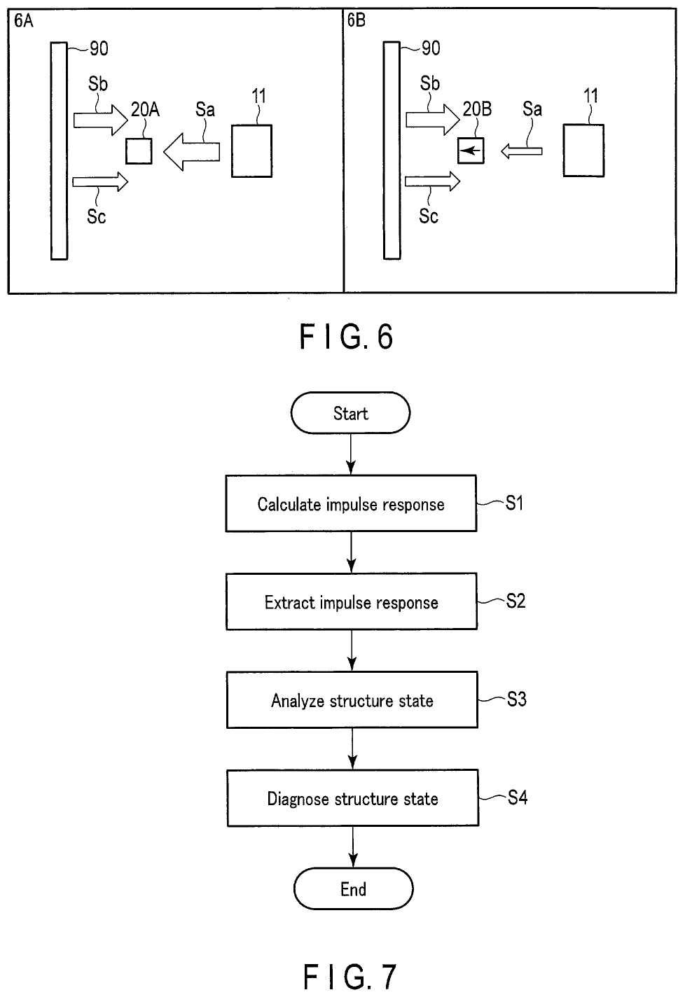

A difference between a case in which the microphones of the sound receiving unit 20 are nondirectional microphones and a case in which the microphones of the sound receiving unit 20 are directional microphones will be described next with reference to FIG. 6. FIG. 6 is a view schematically showing two arrangement examples 6A and 6B of the sound receiving unit 20. In the arrangement example 6A, a sound receiving unit 20A includes nondirectional microphones. In the arrangement example 6B, a sound receiving unit 20B includes directional microphones.

Referring to FIG. 6, an arrow Sa represents a radiated sound from the speaker 11, an arrow Sb represents a reflected sound from the diagnosis target object 90, and an arrow Sc represents a vibration radiated sound from the diagnosis target object 90. The widths of the arrows Sa, Sb, and Sc each represent the magnitude of a sound wave received by the sound receiving unit 20A or 20B.

In the arrangement example GA, the sound receiving unit 20A includes the nondirectional microphones, and thus receives a more radiated sound from the speaker 11. On the other hand, in the arrangement example 6B, the sound receiving unit 20B includes the directional microphones, and thus receives a less radiated sound from the speaker 11. Therefore, as compared with the sound receiving unit 20A including the nondirectional microphones, the sound receiving unit 20B including the directional microphones highly contributes to acquisition of a reflected sound and a vibration radiated sound representing a change in acoustic characteristic of the diagnosis target object 90.

(Diagnostic Processing by Diagnostic Processing Unit 30)

The procedure of diagnostic processing executed by the diagnostic processing unit 30 will be described next with reference to FIG. 7. FIG. 7 is a flowchart illustrating the procedure of the diagnostic processing executed by the diagnostic processing unit 30. Assume here that the acoustic vibration signal generation unit 34 continuously inputs, as an acoustic vibration signal, a Logss signal capable of performing nonlinear separation to the speaker 11.

In step S1, the impulse response calculation unit 31 receives a sound reception signal from each of the microphones 21 and 22, and calculates the impulse response of each of the microphones 21 and 22.

In step S2, waveforms in a linear characteristic section and respective distortion characteristic sections are extracted from each impulse response.

Since the Logss signal is used as an acoustic vibration signal, the impulse response extraction processing in step S2 is performed. If, however, a TSP signal other than the Logss signal is used as an acoustic vibration signal, the impulse response extraction processing in step S2 is skipped.

In step S3, the structure state analysis unit 32 performs structure state analysis based on the extracted waveforms in the linear characteristic section and respective distortion characteristic sections. The structure state analysis unit 32 performs structure state analysis based on four kinds of analysis methods. The four kinds of structure state analysis methods will be described later.

In step S4, the structure state diagnostic unit 33 diagnoses the structure state of the diagnosis target object 90 based by the analysis by the structure state analysis unit 32. The diagnostic method will be described later.

(Four Kinds of Analysis Methods)

Structure state analysis based on the four kinds of analysis methods executed by the structure state analysis unit 32 will be described next. The four kinds of analysis methods will be referred to as single microphone frequency characteristic evaluation 1, single microphone frequency characteristic evaluation 2, two-microphone intensity evaluation 1, and two-microphone intensity evaluation 2, respectively, hereinafter, for the sake of convenience. In single microphone frequency characteristic evaluation 1 and single microphone frequency characteristic evaluation 2, the frequency characteristic is evaluated using the sound reception signal of a single microphone as one of the first and second microphones. In two-microphone intensity evaluation 1 and two-microphone intensity evaluation 2, intensity is evaluated using the sound reception signals of both the first and second microphones. Each structure state analysis method will be described below.

(Single Microphone Frequency Characteristic Evaluation 1)

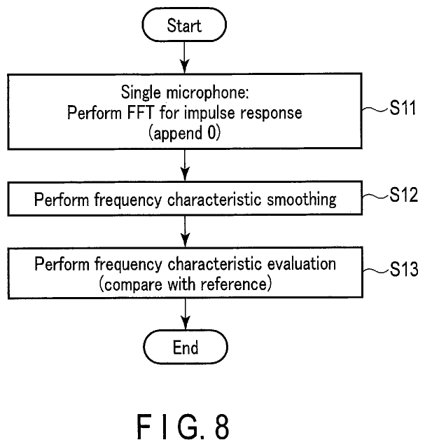

The processing procedure of single microphone frequency characteristic evaluation 1 will be described with reference to FIG. 8. FIG. 8 is a flowchart illustrating the processing procedure of single microphone frequency characteristic evaluation 1.

Since the signal length of the extracted impulse response is short, if FFT is executed, the frequency resolution decreases. To avoid this, in step S11, 0 is appended to the extracted impulse response of the single microphone to have a signal length equal to that before extraction, and FFT is executed for the thus obtained impulse response.

If the result of FFT is used intact in a high frequency range of 1 KHz or more, changes in gain characteristic and phase characteristic are noisy. To avoid this, in step S12, frequency characteristic smoothing is performed for the gain characteristic and the phase characteristic. For example, averaging processing of ±several Hz is performed for each of the gain characteristic and phase characteristic.

Finally, in step S13, frequency characteristic evaluation is performed. More specifically, comparison of the transfer characteristic with the reference state is displayed. For example, the transfer characteristic is superimposed and displayed on the reference state or a difference in transfer characteristic with reference to the reference state is displayed.

(Single Microphone Frequency Characteristic Evaluation 2)

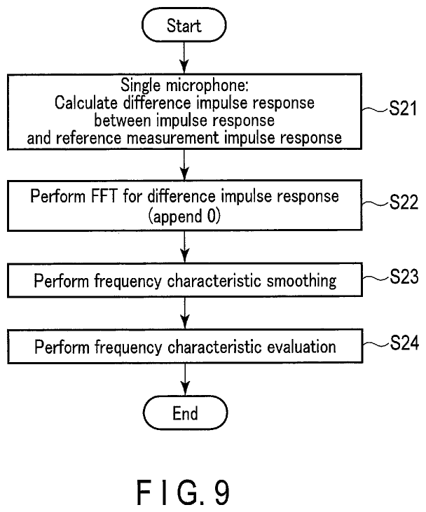

The processing procedure of single microphone frequency characteristic evaluation 2 will be described next with reference to FIG. 9. FIG. 9 is a flowchart illustrating the processing procedure of single microphone frequency characteristic evaluation 2.

In step S21, a difference between a reference measurement extracted impulse response measured in the reference state and the extracted impulse response of the single microphone is calculated.

Since the signal length of the extracted impulse response is short, if FFT is executed, the frequency resolution decreases. To avoid this, in step S22, 0 is appended to the extracted difference impulse response to have a signal length equal to that before extraction, and FFT is executed for the thus obtained difference impulse response.

If the result of FFT is used intact in a high frequency range of 1 KHz or more, changes in gain characteristic and phase characteristic are noisy. To avoid this, in step S23, frequency characteristic smoothing is performed for the gain characteristic and the phase characteristic. For example, averaging processing of ±several Hz is performed for each of the gain characteristic and phase characteristic.

Finally, in step S24, frequency characteristic evaluation is performed. For example, the difference transfer characteristic is displayed.

(Two-Microphone Intensity Evaluation 1)

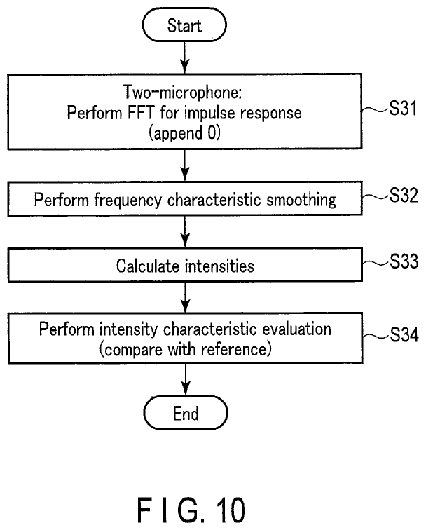

The processing procedure of two-microphone intensity evaluation 1 will be described with reference to FIG. 10. FIG. 10 is a flowchart illustrating the processing procedure of two-microphone intensity evaluation 1.

Since the signal length of the extracted impulse response is short, if FFT is executed, the frequency resolution decreases. To avoid this, in step S31, 0 is appended to the extracted impulse response of each of the two microphones to have a signal length equal to that before extraction, and FFT is executed for the thus obtained impulse response.

If the result of FFT is used intact in a high frequency range of 1 KHz or more, changes in gain characteristic and phase characteristic are noisy and the intensity characteristic cannot be displayed correctly. To avoid this, in step S32, frequency characteristic smoothing is performed for the gain characteristic and the phase characteristic. For example, averaging processing of ±several Hz is performed for each of the gain characteristic and phase characteristic. After that, conversion into a complex number for each frequency is performed. Furthermore, in step S33, active intensity and reactive intensity are calculated using smoothed FFT values.

Finally, in step S34, intensity characteristic evaluation is performed. More specifically, comparison of the intensity characteristic with the reference state is displayed. For example, the intensity characteristic is superimposed and displayed on the reference state or a difference in intensity characteristic or the ratio of the intensity characteristic with reference to the reference state is displayed.

(Two-Microphone Intensity Evaluation 2)

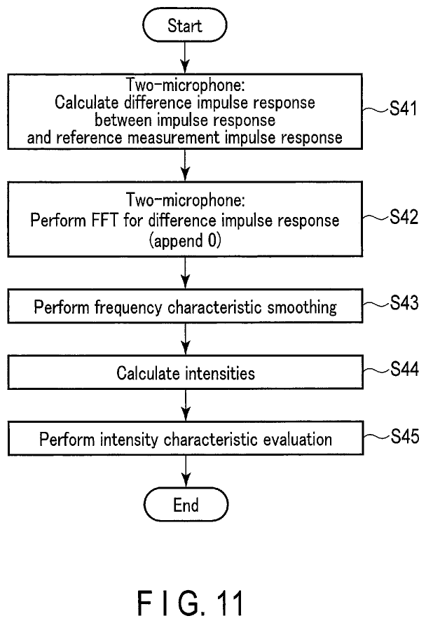

Finally, the processing procedure of two-microphone intensity evaluation 2 will be described with reference to FIG. 11. FIG. 11 is a flowchart illustrating the processing procedure of two-microphone intensity evaluation 2.

In step S41, a difference between a reference measurement extracted impulse response measured in the reference state and the extracted impulse response of each of the two microphones is calculated.

Since the signal length of the extracted impulse response is short, if FFT is executed, the frequency resolution decreases. To avoid this, in step S42, 0 is appended to the extracted difference impulse response of each of the two microphones to have a signal length equal to that before extraction, and FFT is executed for the thus obtained difference impulse response of each of the two microphones.

If the result of FFT is used intact in a high frequency range of 1 KHz or more, changes in gain characteristic and phase characteristic are noisy and the intensity characteristic cannot be displayed correctly. To avoid this, in step S43, frequency characteristic smoothing is performed for the gain characteristic and the phase characteristic. For example, averaging processing of ±several Hz is performed for each of the gain characteristic and phase characteristic. After that, conversion into a complex number for each frequency is performed. Furthermore, in step S45, active intensity and reactive intensity are calculated using smoothed FFT values.

Finally, in step S45, intensity characteristic evaluation is performed. For example, the active intensity and the reactive intensity are displayed.

(Auxiliary Structure State Analysis)

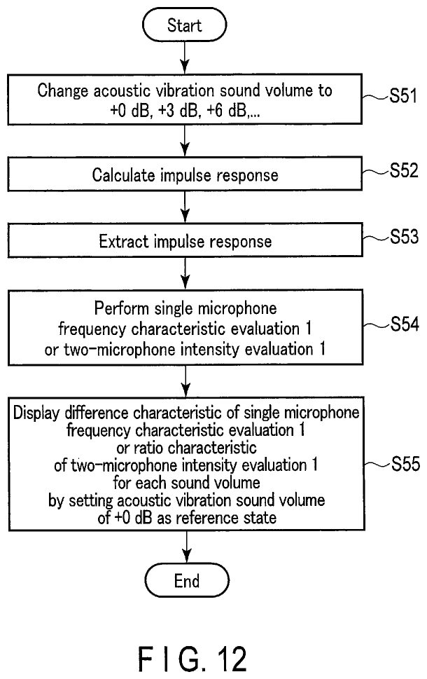

The processing procedure of auxiliary structure state analysis will now be described with reference to FIG. 12. FIG. 12 is a flowchart illustrating the processing procedure of auxiliary structure state analysis. This auxiliary structure state analysis is auxiliary applied to single microphone frequency characteristic evaluation 1 or two-microphone intensity evaluation 1 described above, and need not always be performed.

In step S51, the speaker 11 is caused to apply an acoustic vibration while sequentially changing an acoustic vibration sound volume (+0 dB (the reference sound volume is set to 0 dB), +3 dB, +6 dB, . . . ).

In step S52, a sound reception signal is received from each of the microphones 21 and 22 and the impulse response of each of the microphones 21 and 22 is calculated.

In step S53, waveforms in a linear characteristic section and respective distortion characteristic sections are extracted from each impulse response.

In step S54, single microphone frequency characteristic evaluation 1 or two-microphone intensity evaluation 1 is performed.

In step S55, by setting an acoustic vibration sound volume of +0 dB as the reference state, the difference characteristic of single microphone frequency characteristic evaluation 1 or the ratio characteristic of two-microphone intensity evaluation 1 at each sound volume is displayed.

In evaluation of the linear characteristic section, a linear change is confirmed, and if the change deviates, it can be determined that there is a problem in a measurement environment. In the nonlinear characteristic section (distortion characteristic), no linear change occurs, and it is thus possible to assist diagnosis of deterioration by monitoring a change in characteristic in each state.

(Acoustic Vibration Signal)

As described above, the acoustic vibration signal is a TSP (Time Stretched Pulse) signal. As one example of the TSP signal, a Logss (Log Swept Sine) signal will be described. A method of calculating the distortion occurrence time in the Logss signal will be described. For example, the definitional equation of the frequency characteristic of the Logss signal is represented using equations (1) to (3) below. Note that N represents the length of the Logss signal, q represents an arbitrary real number (J is a multiple of 2), N and q are setting variables, and j represents an imaginary number.

$$LOGSS ( i ) = \{ \begin{matrix}1 & ( i = 0 ) \\ \frac{exp ( - j α \times i log ( i ) \}}{√ i} & ( 1 \leq i \leq \frac{N}{2} ) \\ \frac{exp ( - j α \times ( N - i ) log ( N - i ) \}}{\sqrt{N - i}} & ( \frac{N}{2} + 1 \leq i \leq N - 1 )\end{matrix} \qquad ( 1 )$$

$$J = ( q ) \times N \qquad ( 2 )$$

$$α = \frac{J π}{\frac{N}{2} log ( \frac{N}{2} )} \qquad ( 3 )$$

Based on equations (1) to (3), the Logss signal is given by equation (4) below. Re represents a real part and IFFT represents inverse Fourier transformation.

logss=Re[IFFT(LOGSS)] (4)

Note that the TSP signal generally used is given by equation (5) below in which m represents an integer.

$$T S P ( i ) = \{ \begin{matrix}exp \{ - j 4 m π \times {i}^{2} / {N}^{2} \} & ( 0 \leq i \leq \frac{N}{2} ) \\ exp \{ j 4 m π \times {( N - i )}^{2} / {N}^{2} \} & ( \frac{N}{2} + 1 \leq i \leq N - 1 )\end{matrix} \qquad ( 5 )$$

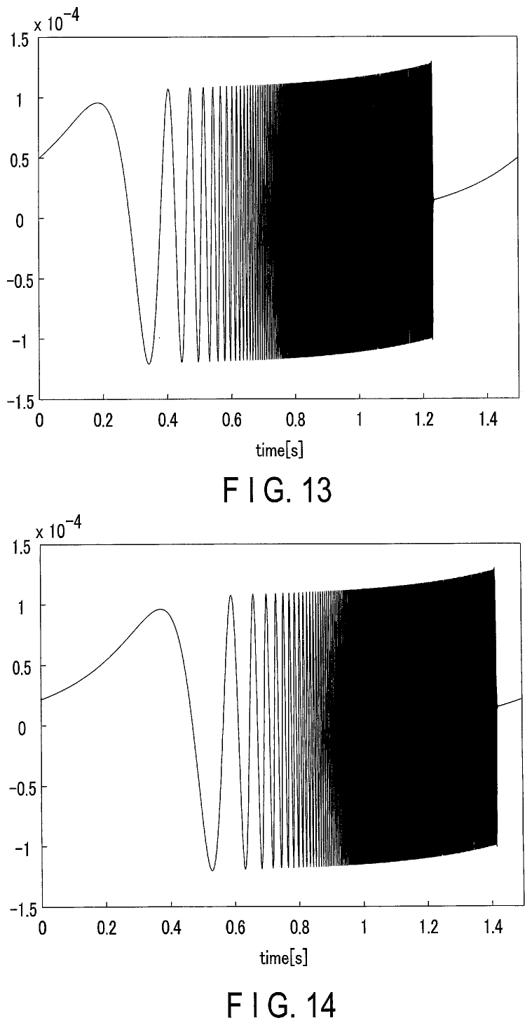

At this time, when a sampling frequency fₛ is set to 44.1 KHz, the length N of the Logss signal is set to 65536 (2¹⁶), and q is set to ¾, the signal given by equation (4) is represented, as shown in FIG. 13. A signal obtained by shifting the signal shown in FIG. 13 by (N−J)/2 is represented, as shown in FIG. 14. In FIGS. 13 and 14, the ordinate represents the level of a speaker application voltage (the level is adjusted by a connected speaker amplifier), and the abscissa represents the time [s]. The Logss signal is generated based on equations (1) to (4), and the signal obtained by shifting the signal by (N−J)/2 is used as an acoustic vibration signal, that is, an input signal to the speaker. Note that the shift amount is not limited to the above one. For example, as shown in FIG. 14, a tap value from 0 s (1 tap) to 0.1 s (0.1×fₛ tap) is set so that a change in a value close to the initial tap value is small.

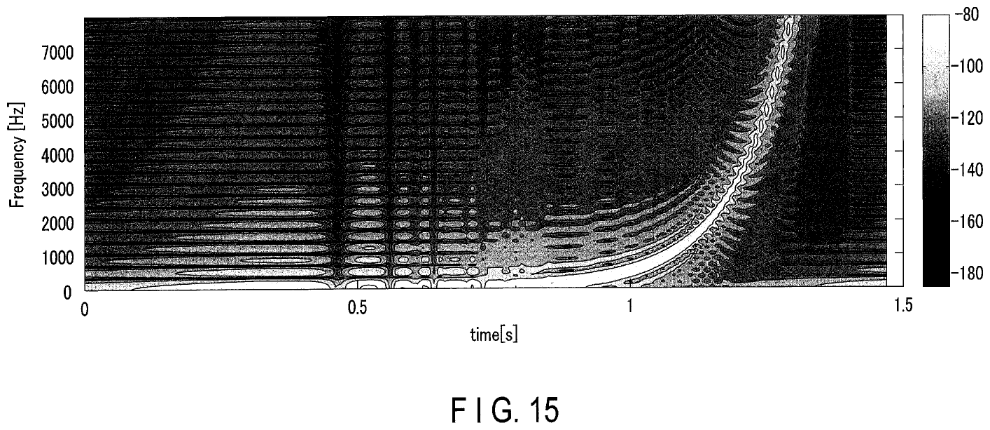

FIG. 15 shows the spectrogram of the Logss signal after the shift shown in FIG. 14. The ordinate represents the frequency [Hz] and the abscissa represents the time [s]. In the spectrogram shown in FIG. 15, by exchanging the ordinate and the abscissa, it will be found that a logarithmic change is obtained. That is, the logarithmic frequency is proportional to the time and the frequency is an exponential function of the time. Therefore, the relationship between the time and the frequency in the spectrogram of the Logss signal is given by equations (6) to (8) below. Note that t_{offset} represents the offset time, and shift represents the above-described shift amount of the Logss signal.

$$t = \frac{J}{{f}_{s} log ( \frac{N}{2} )} log ( f \times \frac{N}{{f}_{s}} ) + {t}_{offset} \qquad ( 6 )$$

$${t}_{offset} = \frac{J}{{f}_{s} log ( \frac{N}{2} )} + \frac{shift}{{f}_{s}} \qquad ( 7 )$$

$$shift = \frac{N - J}{2} \qquad ( 8 )$$

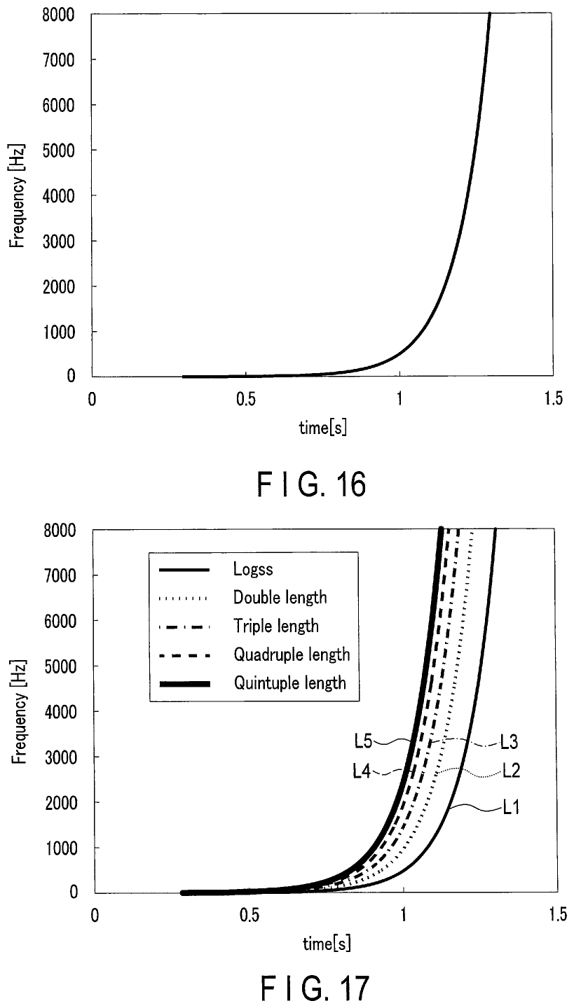

FIG. 16 is a timing chart showing the relationship between the time and the frequency in the spectrogram of the Logss signal given by equations (6) to (8) above. In FIG. 16, the ordinate represents the frequency [Hz] and the abscissa represents the time [s].

At this time, if a harmonic distortion occurs in the Logss signal when there is no dynamic characteristic, a timing chart shown in FIG. 17 is obtained. FIG. 17 shows the spectrogram obtained when a harmonic distortion occurs in the Logss signal with the spectrogram shown in FIG. 16. A line L1 is the curve of a basic response given by equations (6) to (8), a line L2 is the curve of the second harmonic response (the response curve of a first-order distortion), a line L3 is the curve of the third harmonic response (the curve of a second-order distortion), a line L4 is the curve of the fourth harmonic response (the curve of a third-order distortion), and a line L5 is the curve of the fifth harmonic response (the curve of a fourth-order distortion).

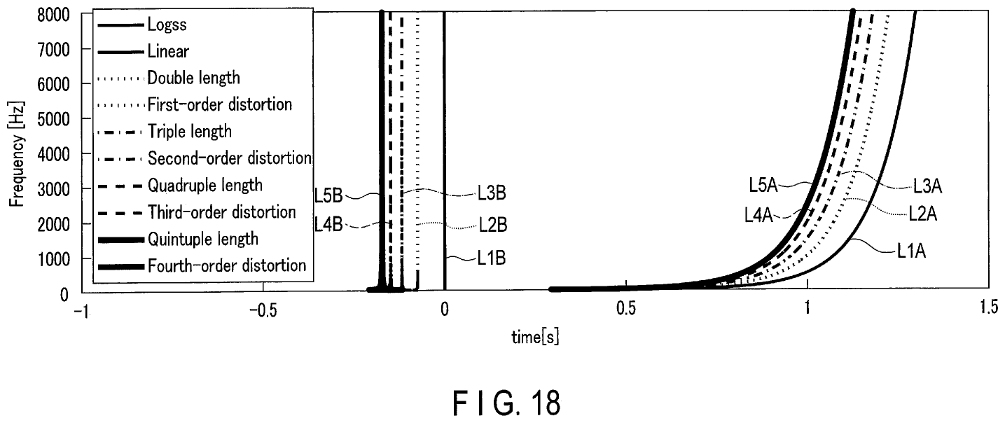

When such harmonic distortion occurs in the Logss signal, the curve of the above-described measured response is converted based on the inverse characteristic of the Logss signal, thereby obtaining a timing chart shown in FIG. 18. FIG. 18 shows an impulse response obtained by converting the response curve of the Logss signal with the spectrogram shown in FIG. 17 based on the inverse characteristic of the Logss signal. The ordinate represents the frequency [Hz] and the abscissa represents the time [s]. Lines L1A, L2A, L3A, L4A, and LSA are the response curves of the lines L1 to L5, respectively. A line L1B represents an impulse response corresponding to the basic response. A line L2B represents an impulse response corresponding to the second harmonic response (the distortion characteristic of the first-order distortion). A line L3B represents an impulse response corresponding to the third harmonic response (the distortion characteristic of the second-order distortion). A line L4B represents an impulse response corresponding to the fourth harmonic response (the distortion characteristic of the third-order distortion). A line L5B represents an impulse response corresponding to the fifth harmonic response (the distortion characteristic of the fourth-order distortion). The thus calculated impulse response corresponding to the harmonic response appears in a time region before time 0, that is, in a negative time region (a region in a non-causal direction). If, however, the distance between the speaker and the microphone is long, the rising time of the linear response is delayed, and thus the impulse response corresponding to the harmonic response may occur in a positive time region. A description will be provided here under the condition that there is no time delay (no dynamic characteristic). The impulse response corresponding to the harmonic response is separated into distortions of respective orders in the region in the non-causal direction. In this embodiment, by using the Logss signal as an input signal, it is possible to separate the impulse response into distortions of respective orders, and analyze the distortions of the respective orders using the distortion characteristics of the distortions of the respective orders. In normal TSP, only the linear response can be obtained.

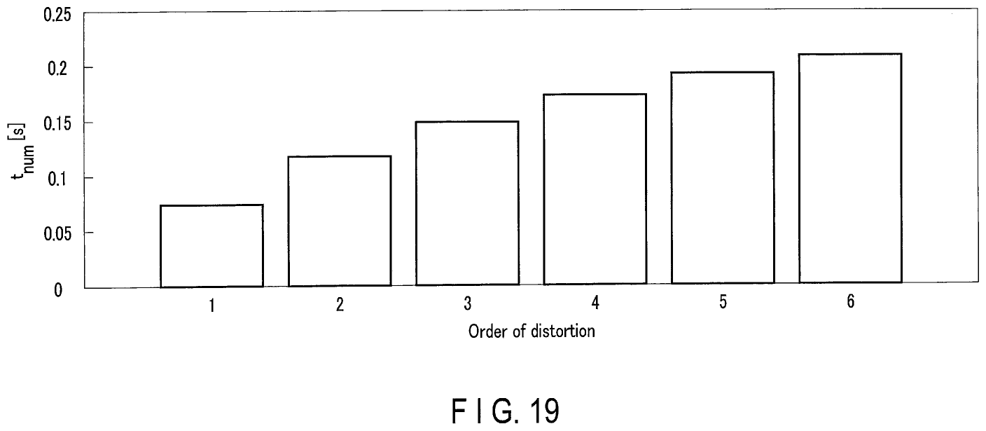

Furthermore, by separating the distortion characteristic, as described above, the distortion characteristics of the respective orders are separated into different time regions. At this time, the occurrence time (−t(num) [s]) of the distortion characteristic of each order is given by equation (9) below where num represents the order of the distortion. For example, by making the above-described settings, the occurrence times of the distortion characteristics shown in FIG. 18 are as shown in FIG. 19. In FIG. 19, the abscissa represents the distortion order and the ordinate represents the time [s].

$$\begin{matrix}{t}_{num} = \frac{J}{{f}_{s} log ( \frac{N}{2} )} \{ log ( \frac{N ( n u m + 1 ) {f}_{c}}{{f}_{s}} ) - log ( \frac{N {f}_{c}}{{f}_{s}} ) \} \\ = \frac{J}{{f}_{s} log ( \frac{N}{2} )} log ( n u m + 1 )\end{matrix} \qquad ( 9 )$$

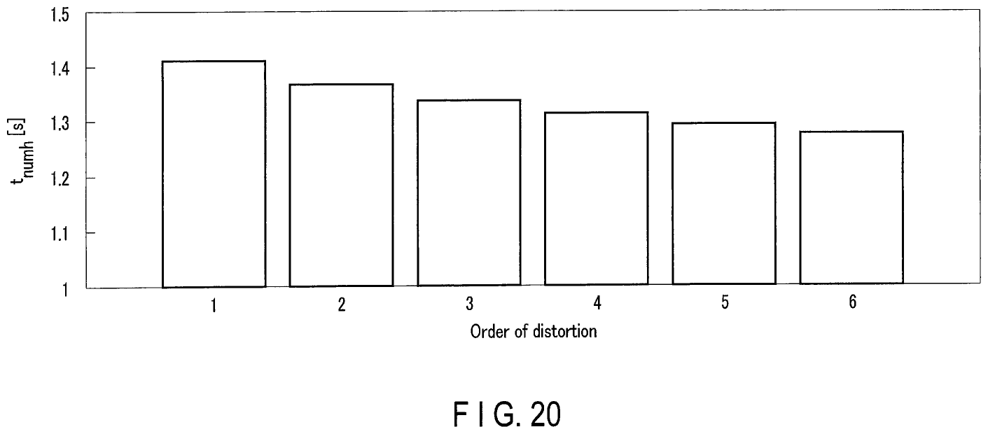

Then, based on the occurrence time of the distortion characteristic of each order with reference to the impulse response corresponding to the basic response, the distortion occurrence time in the derived impulse response is given by equation (10) below, because of the repeatability of discrete Fourier transformation.

$${t}_{numh} = \{ \begin{matrix}\frac{N}{{f}_{s}} - {t}_{n u m} + {t}_{a} & ( {t}_{n u m} > {t}_{a} ) \\ {t}_{a} - {t}_{n u m} & ( {t}_{num} < {t}_{a} )\end{matrix} \qquad ( 10 )$$

where ta represents the delay time (to also be referred to as a “wasted time” hereinafter) of the dynamic characteristic, and is decided by L/c using the distance L between the speaker and the microphone in which c represents the speed of sound. More strictly, the delay characteristic of the speaker or that of the system is also added to ta. ta corresponds to the rising time of the first wave in the causal direction, satisfying causality, as the opposite direction of the non-causal direction. If, for example, the distance L between the speaker and the microphone is sufficiently short and ta can be regarded as 0, in the above-described settings, the distortion occurrence times in the impulse response are as shown in FIG. 20. In FIG. 20, the abscissa represents the distortion order and the ordinate represents the time [s].

(Method of Calculating Impulse Response from TSP Signal)

The above-described TSP signal is input as a speaker application voltage to the speaker amplifier, thereby driving the speaker 11.

Each of the microphones 21 and 22 of the sound receiving unit 20 measures, as a sound pressure, a direct sound from the speaker 11, a reflected sound from the diagnosis target object 90, and a vibration radiated sound from the diagnosis target object 90, all of which accompany the acoustic vibration of the speaker. In the case of LDV measurement, the vibration velocity of the diagnosis target object 90 is measured.

The impulse response calculation unit 31 calculates an impulse response based on the speaker application voltage and a microphone acquisition sound pressure response. The speaker application voltage is generated based on signals obtained by arranging TSP signals (Logss signals or the like) for a predetermined number of times. The impulse response calculation unit averages the sound and subsequent pressure changes of the second time in the sound reception signal by setting the length of the TSP signal (Logss signal or the like) as the length for once. The impulse response calculation unit 31 performs fast Fourier transformation (FFT) for the averaged signal. The impulse response calculation unit multiplies the signal after the FFT processing by the inverse characteristic of the TSP signal (Logss signal or the like) in the speaker application voltage in the frequency domain. The impulse response calculation unit calculates an impulse response by performing inverse fast Fourier transformation (inverse FFT) for the signal obtained by performing the multiplication processing.

Note that in accordance with the frequency band in which the speaker 11 can output a signal, the TSP signal may be filtered using a bandpass filter, thereby obtaining the speaker application voltage. This can increase the output level (speaker amplifier) of the speaker. At this time, the impulse response calculation unit may appropriately correct the influence of filtering using the bandpass filter in the processing in the frequency domain.

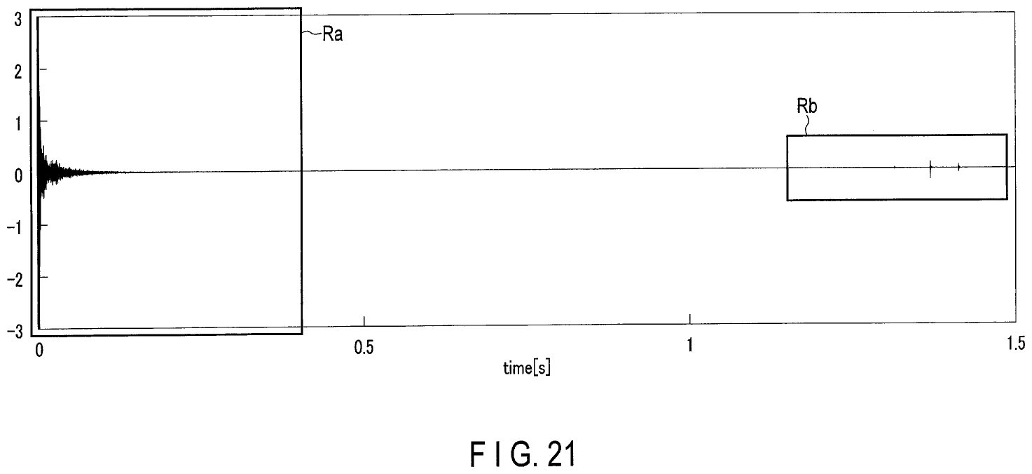

FIG. 21 is a timing chart showing an example of the impulse response calculated, as described above, in the above-described settings. In FIG. 21, the abscissa represents the time [s] and the ordinate represents the level of the impulse response. The impulse response shown in FIG. 21 is derived from the microphone response of the sound receiving unit 20 with respect to the acoustic vibration of the speaker based on the Logss signal. The impulse response is the dynamic characteristic including the speaker characteristic, the acoustic space characteristic, and the acoustic characteristic of the diagnosis target object 90. Therefore, the linear characteristic of the dynamic characteristic appears in a region Ra, and the nonlinear characteristic (distortion characteristic) of the dynamic characteristic appears in a region Rb. The region Ra corresponds to a period (about several sec) from the time immediately before the time corresponding to the peak value of the impulse response to the time when a residual response (reverberation response) occurs (linear characteristic section). The region Rb is set in accordance with the distortion occurrence times shown in FIG. 20 in a region other than the region Ra.

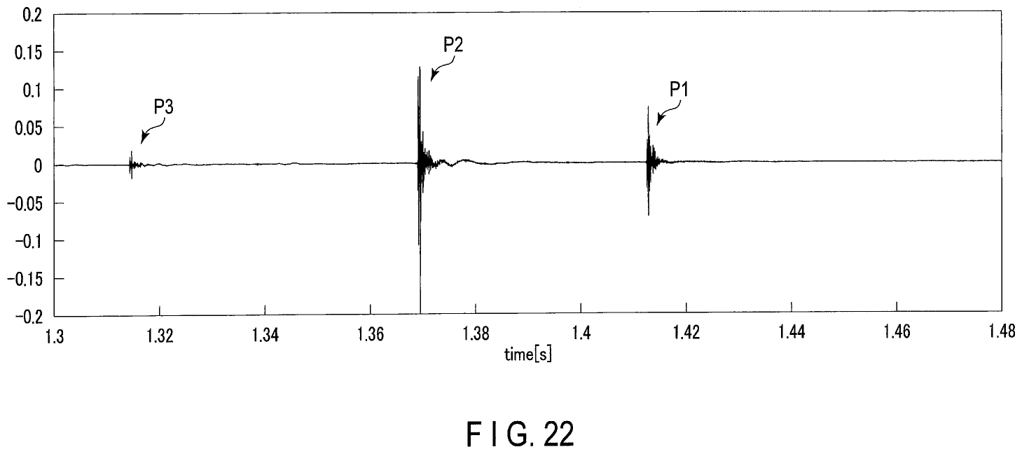

FIG. 22 is an enlarged view of the region Rb corresponding to the nonlinear characteristic of the impulse response. In FIG. 22, the abscissa represents the time and the ordinate represents the level of the impulse response. Based on FIG. 20, a first-order distortion p1, a second-order distortion p2, and a third-order distortion p3 appear in the order shown in FIG. 22.

(Intensity Calculation Method)

A method of obtaining the intensity on a line segment connecting the first microphone 21 and the second microphone 22 installed at an interval of a distance d will be described next. With reference to the first microphone 21, the first microphone 21 and the second microphone 22 are arranged in this order in the positive direction of the intensity measurement axis.

When G₁(ω) and G₂(ω) represent transfer characteristics acquired via the first microphone 21 and the second microphone 22 at the time of acoustic vibration measurement, respectively, active intensity representing the flow of energy of a sound wave on the measurement axis can be obtained by:

$$I ( ω ) = \frac{- 1}{ω ρ d} Im ( {G}_{1}^{*} ( ω ) {G}_{2} ( ω ) ) \qquad ( 11 )$$

Note that each transfer characteristic is calculated by performing FFT for the impulse response. If the TSP signal is the Logss signal, 0 is appended to the extracted impulse response, and FFT is performed, thereby calculating each transfer characteristic.

Since the particle velocity is approximated using the two microphones 21 and 22 arranged at an interval of the distance d, the upper limit of the measurement range frequency is set to about fₘₐₓ=c/(10d) corresponding to λ=10d in consideration of the measurement accuracy.

Furthermore, reactive intensity indicating the sound pressure square gradient is obtained by:

$$Q ( ω ) = \frac{{G}_{1}^{*} ( ω ) {G}_{1} ( ω ) - {G}_{2}^{*} ( ω ) {G}_{2} ( ω )}{2 ω ρ d} \qquad ( 12 )$$

Note that, as described above, if the FFT value is used intact in a high frequency range of 1 KHz or more, display of the intensity characteristic is noisy. Therefore, with respect to the FFT value, a value obtained by performing, at frequencies of ±several Hz, the gain and phase averaging processing is returned to a complex number, and the intensity is calculated.

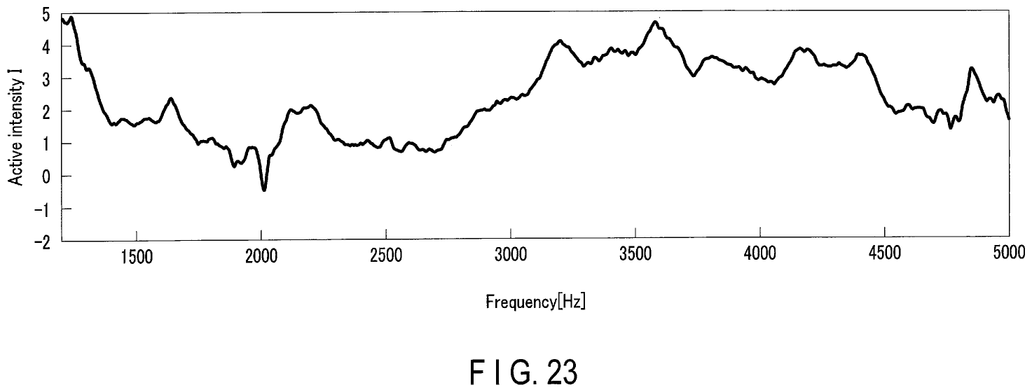

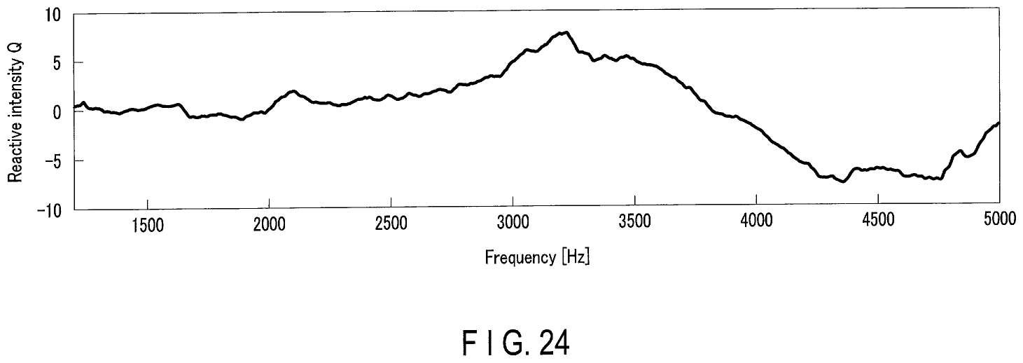

FIGS. 23 and 24 show examples of measurement when the distance d between the microphones is 5 mm. FIG. 23 is a graph of an example of measurement of active intensity. FIG. 24 is a graph of an example of measurement of reactive intensity. Note that as the FFT value, a value obtained by returning, to a complex number, a value obtained by performing, at frequencies of ±20 Hz, the gain and phase averaging processing is used.

(Acoustic. Evaluation)

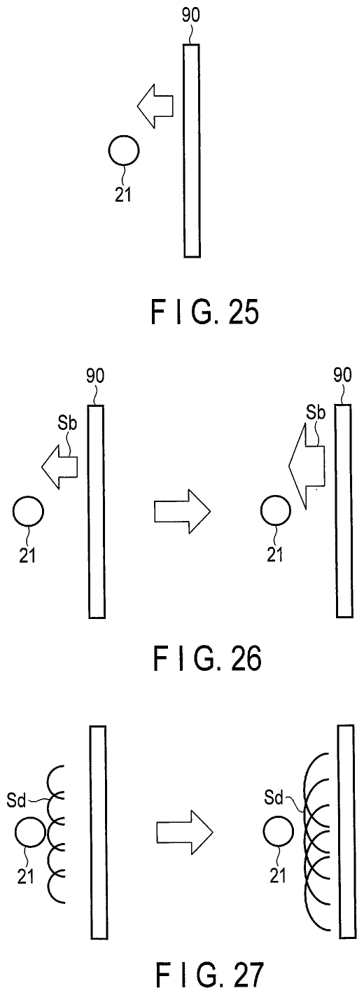

A change in sound pressure will be described with reference to FIGS. 25, 26, and 27. FIG. 25 is a view schematically showing the one microphone 21 and the diagnosis target object 90 in a reference state. FIG. 26 is a view schematically showing a state in which the sound absorption characteristic of the diagnosis target object 90 deteriorates, as compared with the reference state. FIG. 27 is a view schematically showing a state in which a small vibration of the diagnosis target object 90 increases, as compared with the reference state.

It is assumed that a change in sound pressure from the reference state (FIG. 25) physically means that when the sound pressure of the microphone 21 increases, the sound absorption characteristic deteriorates (FIG. 26) or the small vibration increases (FIG. 27), as compared with the reference state. To the contrary, it is assumed that when the sound pressure of the first microphone 21 decreases, the sound absorption characteristic increases or the small vibration decreases, as compared with the reference state. However, in sound pressure evaluation, it may be impossible to correctly grasp the change due to the influence of ambient reflection, and measurement point dependency such as sound wave interference is high. Note that even if correct evaluation is not implemented, it is possible to grasp the change tendency.

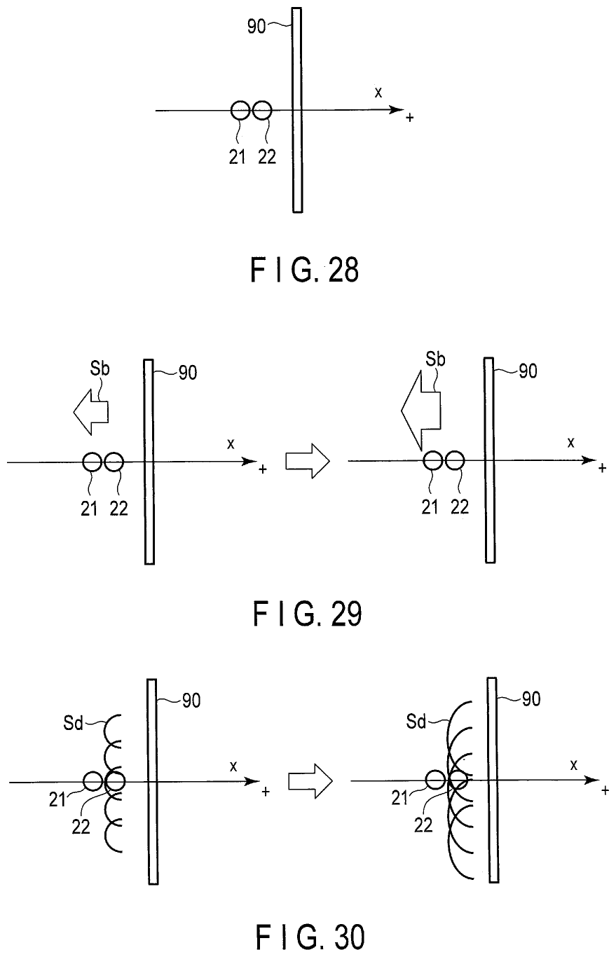

A change in active intensity will be described next with reference to FIGS. 28, 29, and 30. FIG. 28 is a view schematically showing the two microphones 21 and 22 and the diagnosis target object 90 in a reference state. FIG. 29 is a view schematically showing a state in which the sound absorption characteristic of the diagnosis target object 90 increases, as compared with the reference state. FIG. 30 is a view schematically showing a state in which a small vibration of the diagnosis target object 90 decreases, as compared with the reference state.

It is assumed that a change in intensity (positive direction: a direction toward the diagnosis target object 90) from the reference state (FIG. 28) physically means that when the value of the measured active intensity increases, the sound absorption characteristic increases (FIG. 29) or the small vibration decreases (FIG. 30), as compared with the reference state. To the contrary, it is assumed that when the value of the measured active intensity decreases, the sound absorption characteristic deteriorates or the small vibration increases, as compared with the reference state. Since the flow of energy on the measurement axis is acquired, the influence of ambient reflection can be reduced, as compared with the single microphone, and it is thus possible to grasp a change in acoustic characteristic of the diagnosis target object 90 more correctly.

In addition, since reactive intensity indicates the sound pressure square gradient, it is difficult to define the significance of a change in value but it is possible to similarly grasp a change in acoustic characteristic of the diagnosis target object.

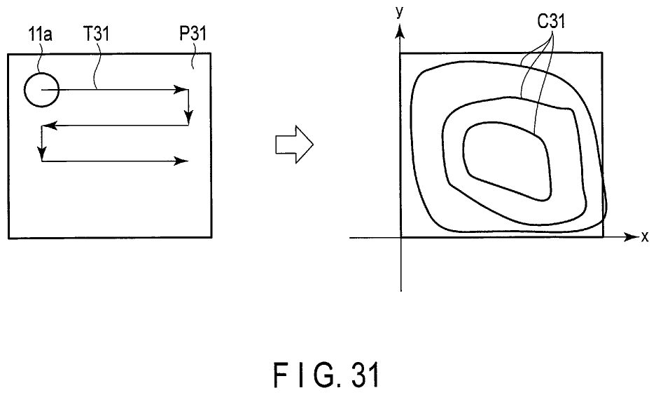

Furthermore, the center of the acoustic vibration may be moved on the plane using, for example, the moving mechanism 18 shown in FIG. 1. FIG. 31 is a view schematically showing the state of the movement of the center of the acoustic vibration, that is, a center 11a of the speaker and display of the contour lines of the measurement result. The center 11a of the speaker is moved along a trajectory T31 on a plane P31 parallel to the plane of the diagnosis target object. With respect to the intensity measurement result, intensity at each measurement point is displayed by contour lines C31 for each frequency of interest. Display by the contour lines C31 makes it easy to perform comparison with the reference state. Since reactive intensity indicates the sound pressure square gradient, it can be used to identify the occurrence position of a sound source (a vibration radiated sound or the like).

(Structure State Diagnosis)

A diagnostic method executed by the structure state diagnostic unit 33 will be described next. Three diagnostic methods will now be described.

The first diagnostic method is a method generally used in deterioration diagnosis, in which comparison with a baseline is performed. In this method, measurement at the time of occurrence of a failure mode (deterioration of a joining force, a welding defect, cracking, or hollowing) is performed in advance, and the baseline of the allowable range is also measured. Measurement analysis data obtained by the structure state analysis unit 32 is compared with the baseline, and it is determined whether transition is performed to a dangerous line.

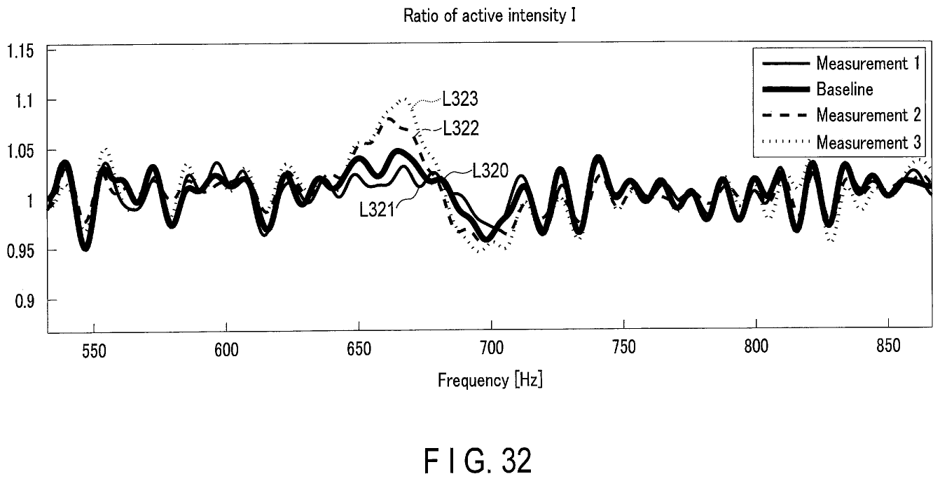

For example, FIG. 32 is a graph showing the measurement analysis data and the baseline of the ratio of the active intensity. This graph is obtained by two-microphone intensity evaluation 1 shown in FIG. 10. Referring to FIG. 32, a line L320 is the curve of the baseline. Lines L321, L322, and L323 are the curves of the measurement analysis data of the ratios of the active intensity obtained by measurements 1, 2, and 3, respectively. Measurement 1 indicates measurement performed first, measurement 2 indicates measurement performed after measurement 1, and measurement 2 indicates measurement performed after measurement 2.

The line L321 obtained in measurement 1 is mostly below the line L320 of the baseline at all the frequencies. On the other hand, the lines L322 and L323 obtained in measurements 2 and 3 greatly exceed the line L320 of the baseline in a frequency band of 640 to 680 Hz. Therefore, a normal state is determined for measurement 1 and an abnormal state is determined for measurements 2 and 3.

The method of determining an abnormal state when the measurement analysis data exceeds the baseline has been explained but there is also a method of determining an abnormal state when the measurement analysis data is below the baseline, as a matter of course.

The second diagnostic method is deterioration progress diagnosis by a change over time, and determines an abnormal state by determining, by monitoring a time-series change, whether the measurement analysis data obtained by the structure state analysis unit 32 tends to increase or decrease. For example, in the graph shown in FIG. 32, in a frequency band of 640 to 680 Hz, it is confirmed that the line L322 of measurement 2 is higher than the line L321 of measurement 1, the line L323 of measurement 3 is higher than the line L322 of measurement 2, and the ratio of the active intensity tends to increase, thereby determining an abnormal state.

The third diagnostic method is diagnosis of peeling of a damping material adhered to the diagnosis target object 90, and is a determination method using the fact that the diagnosis target object 90 such as a plate material (surface material) obtains the sound absorption characteristic by vibrating.

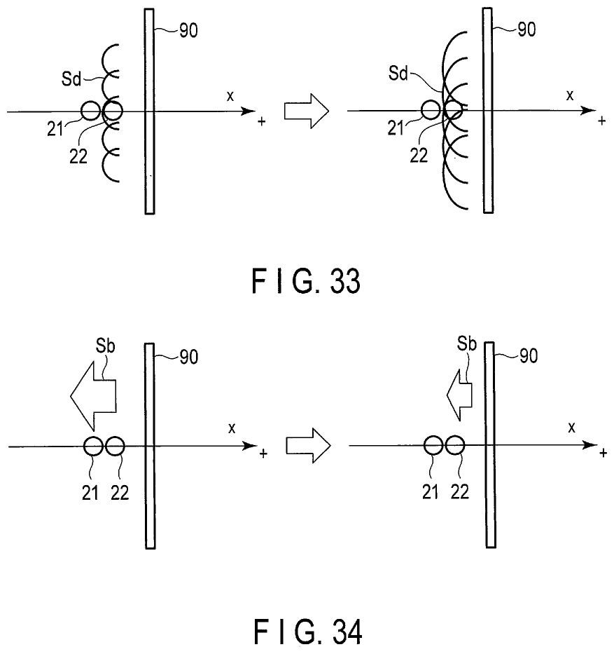

FIG. 33 is a view schematically showing a state in which the small vibration of the diagnosis target object 90 increases after peeling of the damping material (on the right side), as compared with a state before peeling of the damping material (on the left side). FIG. 34 is a view schematically showing a state in which the sound absorption characteristic of the diagnosis target object 90 increases after peeling of the damping material (on the right side), as compared with a state before peeling of the damping material (on the left side).

In general, if the damping material peels off, the plate material vibrates (FIG. 33), thereby increasing the sound absorption characteristic (FIG. 34). That is, since the reflected sound is reduced, the sound pressure tends to decrease, and the measured intensity increases. In this example, the positive direction of measurement is set to a direction toward the diagnosis target object 90.

In the frequency band in which the vibration radiated sound is conspicuous, the sound pressure tends to increase, and the measured intensity may decrease. However, since the contribution of the vibration radiated sound is small in the low frequency band, it is possible to indirectly grasp a change in sound absorption characteristic by monitoring a change in intensity. The natural frequency of the plate material fluctuates in the antiresonance/resonance shape or the resonance/antiresonance shape with respect to the difference or ratio with respect to the reference characteristic. Therefore, even if such shape is generated, the influence of peeling can be diagnosed. In a frequency band around the natural frequency, a frequency at which the maximum intensity is obtained may be acquired and compared, as a matter of course.

As described above, in the embodiment, an acoustic vibration is applied to the diagnosis target object and a sign of deterioration of the diagnosis target object is obtained based on a change in acoustic characteristic (by focusing on the linear characteristic). Since a change in acoustic characteristic is also caused by a change inside the structure or on the rear surface, it is possible to grasp a change that cannot be evaluated by image diagnosis for diagnosing a surface change. Furthermore, if the Logss signal is used as the TSP signal, it is possible to perform not only evaluation of the linear characteristic but also evaluation of the distortion characteristic represented by a “chatter vibration”.

### Example

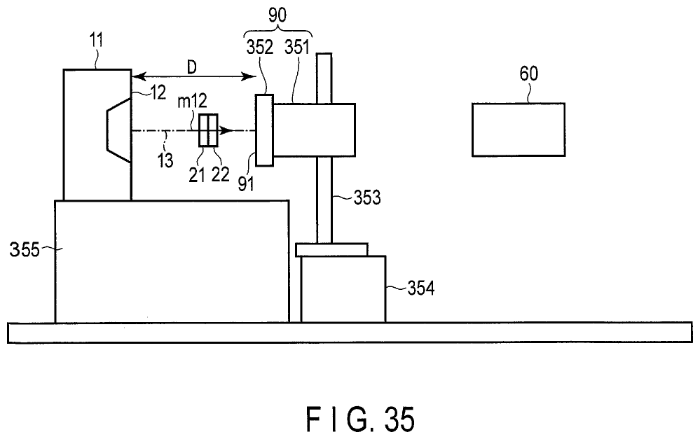

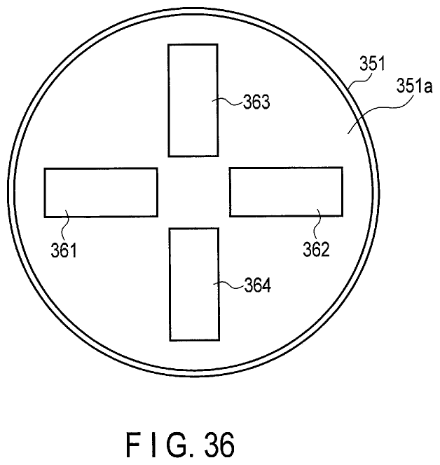

Adequacy of acoustic diagnosis according to the embodiment will be described below. An example of diagnosis of peeling of the damping material will be explained. Conditions for diagnosis of peeling will be described first with reference to FIGS. 35 and 36. FIG. 35 is a view showing the arrangement relationship among the speaker 11, the microphones 21 and 22, and the diagnosis target object 90 in the example of diagnosis of peeling of the damping material. FIG. 36 is a view showing damping materials 361, 362, 363, and 364 adhered to a bottom plate 351a of a steel can 351.

As shown in FIG. 35, the speaker 11 was placed on a base 355. The diagnosis target object 90 was the steel can 351 whose bottom plate 351a was covered with a plastic cap 352. The steel can 351 was supported by a stand 353 placed on a base 354. The speaker 11 and the diagnosis target object 90 were arranged so that the front 12 of the speaker 11 was parallel to the plane 91 of the diagnosis target object 90 and the interval D between the front 12 and the plane 91 was 300 mm. The first microphone 21 and the second microphone 22 were supported by an arm stand (not shown) at an interval of 5 mm, and arranged between the speaker 11 and the diagnosis target object 90. A measurement axis m12 passing through the first microphone 21 and the second microphone 22 was arranged on the speaker axis 13. The interval between the second microphone 22 and the plane 91 of the diagnosis target object 90 was adjusted to 50 mm. Intensity measurement was performed by the first microphone 21 and the second microphone 22. The positive direction of measurement was set to a direction toward the diagnosis target object 90.

To evaluate adequacy of intensity measurement, the LDV was arranged on the opposite side of the microphones 21 and 22 with reference to the diagnosis target object 90, and LDV measurement was also performed from the rear surface. Since the bottom plate 351a of the steel can 351 was covered with the plastic cap 352, it was difficult to perform LDV measurement. That is, it was set not to measure the vibration surface of the bottom plate.

As shown in FIG. 36, measurement was performed in each of a state in which the four damping materials 361 to 364 were adhered to the bottom plate 351a of the steel can 351, a state in which the three damping materials 361 to 363 were adhered to the bottom plate 351a, a state in which the two damping materials 361 and 362 were adhered to the bottom plate 351a, a state in which the one damping material 361 was adhered to the bottom plate 351a, and a state in which none of the damping materials 361 to 364 were adhered to the bottom plate 351a.

The state in which none of the damping materials 361 to 364 are adhered will be referred to as a state in which 0 damping materials are adhered, hereinafter, for the sake of convenience. Furthermore, a state in which n (n=0, 1, 2, 3, 4) damping materials are adhered will simply be referred to as n damping materials hereinafter. The state in which the four damping materials 361 to 364 were adhered was set as the reference state.

(LDV Measurement)

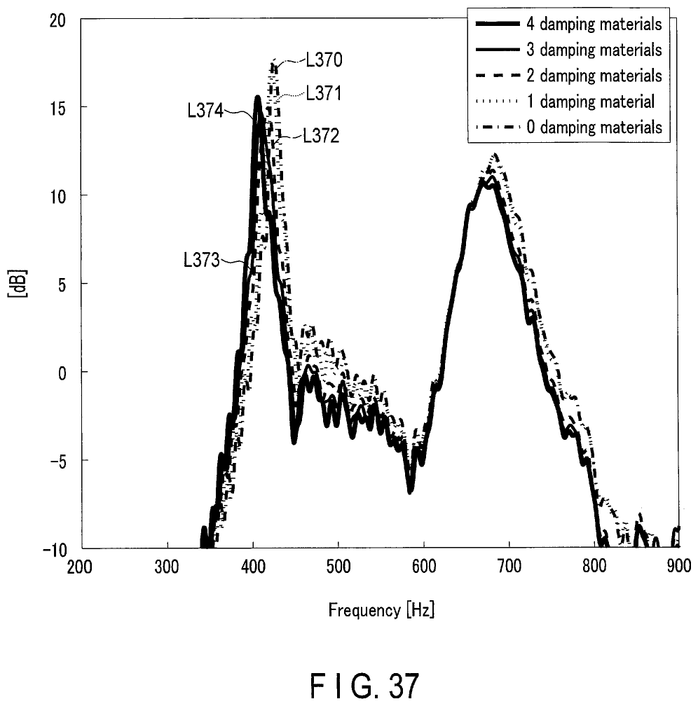

FIGS. 37, 38, 39, and 40 show the results of LDV measurement. LDV measurement was performed for the center of the bottom plate 351a.

FIG. 37 is a graph showing the results of LDV measurement in a frequency band of 200 to 900 Hz. Lines L370, L371, L372, L373, and L374 represent the plots of the measurement results in the states in which the number of damping materials 361 to 364 is 0, 1, 2, 3, and 4.

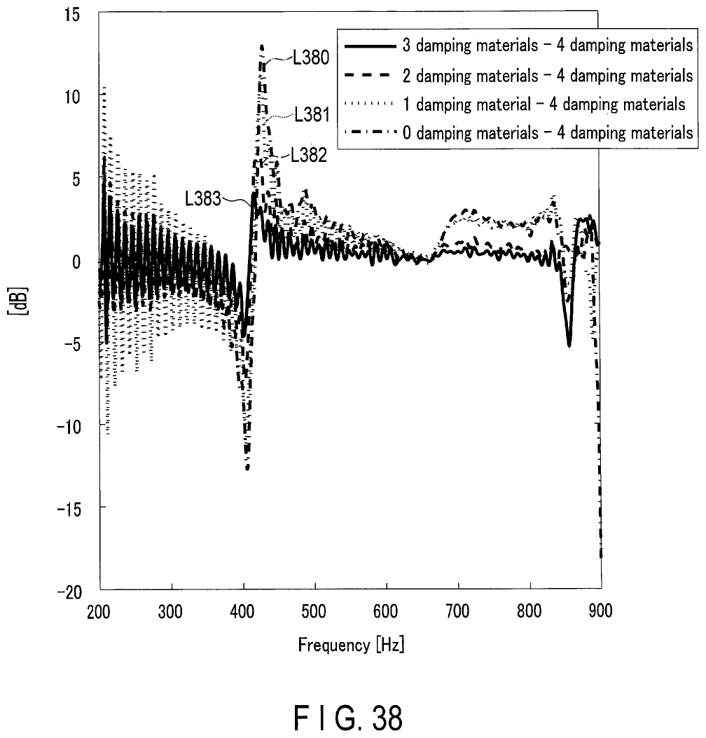

FIG. 38 is a graph showing differences between the results of LDV measurement in a frequency band of 200 to 900 Hz. Lines L380, L381, L382, and L383 represent the plots of differences between the measurement result in the reference state in which the number of damping materials 361 to 364 is 4 and the measurement results in the states in which the number of damping materials 361 to 364 is 0, 1, 2, and 3.

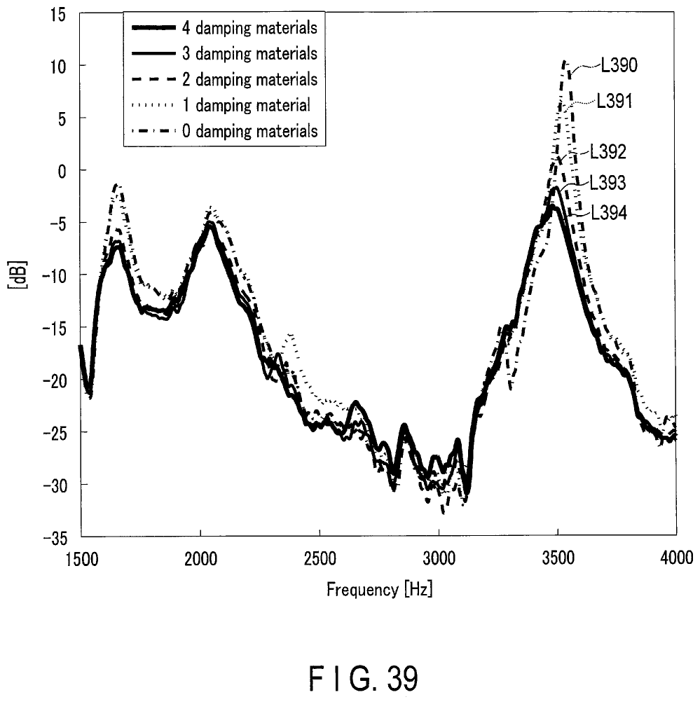

FIG. 39 is a graph showing the results of LDV measurement in a frequency band of 1,500 to 4,000 Hz. Lines L390, L391, L392, L393, and L394 represent the plots of the measurement results in the states in which the number of damping materials 361 to 364 is 0, 1, 2, 3, and 4.

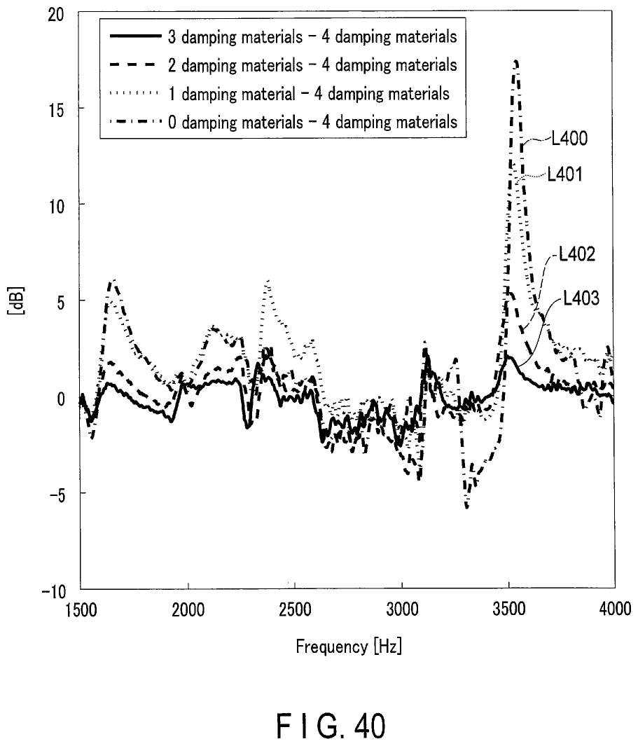

FIG. 40 is a graph showing differences between the results of LDV measurement in a frequency band of 1,500 to 4,000 Hz. Lines L400, L401, L402, and L403 represent the plots of differences between the measurement result in the reference state in which the number of damping materials 361 to 364 is 4 and the measurement results in the states in which the number of damping materials 361 to 364 is 0, 1, 2, and 3.

In the graphs shown in FIGS. 37, 38, 39, and 40, a change in natural frequency caused by peeling of the damping material can be confirmed in a frequency band around 400 Hz, and damping deterioration caused by peeling of the damping material can be confirmed in each of frequency bands of 650 to 750 Hz, 1600 to 1700 Hz, 2000 to 2200 Hz, and 3400 to 3600 Hz.

(Acoustic Vibration and Acoustic Measurement)

It will be described that among the characteristic changes, some signs of deterioration can be obtained in an acoustic vibration and acoustic measurement. That is, it will be described that the above-described changes in status of the rear surface can be correctly obtained as changes in acoustic characteristic.

(Evaluation of Linear Characteristic in 1 KHz or Less)

The linear characteristic in 1 KHz or less is evaluated by four kinds of methods of single microphone frequency characteristic evaluation 1, single microphone frequency characteristic evaluation 2, two-microphone intensity evaluation 1, and two-microphone intensity evaluation 2. In single microphone frequency characteristic evaluation 1 and single microphone frequency characteristic evaluation 2, the second microphone (mic A) is used for acoustic measurement.

(Single Microphone Frequency Characteristic Evaluations 1 and 2)

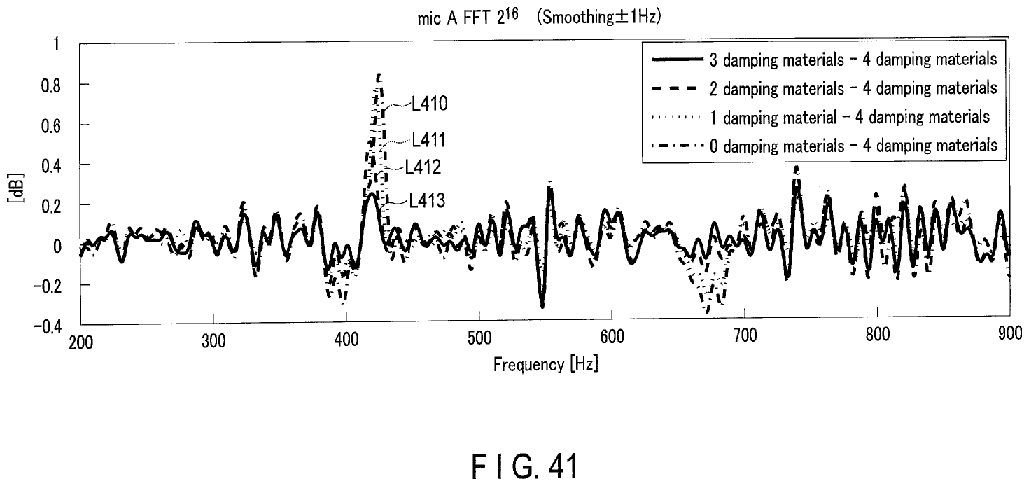

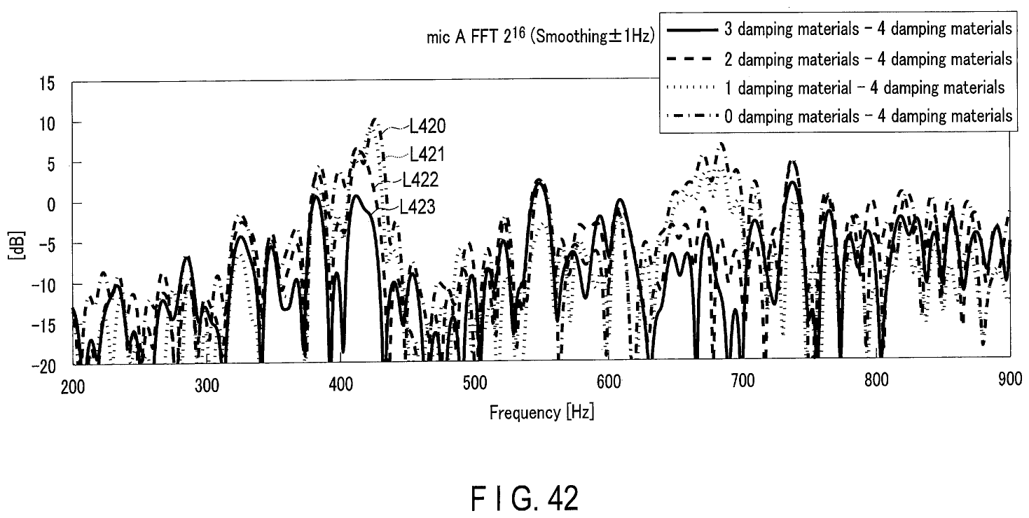

FIG. 41 shows an evaluation result by single microphone frequency characteristic evaluation 1. FIG. 42 shows an evaluation result by single microphone frequency characteristic evaluation 2.

FIG. 41 is a graph showing the evaluation result of a difference transfer characteristic by single microphone frequency characteristic evaluation 1. Lines L410, L411, L412, and L413 represent the plots of differences between the measurement result in the reference state in which the number of damping materials 361 to 364 is 4 and the measurement results in the states in which the number of damping materials 361 to 364 is 0, 1, 2, and 3.

FIG. 42 is a graph showing the evaluation result of a response difference transfer characteristic by single microphone frequency characteristic evaluation 2. Lines L420, L421, L422, and L423 represent the plots of differences between the measurement result in the reference state in which the number of damping materials 361 to 364 is 4 and the measurement results in the states in which the number of damping materials 361 to 364 is 0, 1, 2, and 3.

In both the graphs of the evaluation results by single microphone frequency characteristic evaluation 1 (FIG. 41) and single microphone frequency characteristic evaluation 2 (FIG. 42), a change caused by peeling of the damping material can be confirmed in each of frequency bands of 420 to 430 Hz and 650 to 700 Hz.

(Two-Microphone Intensity Evaluation 1)

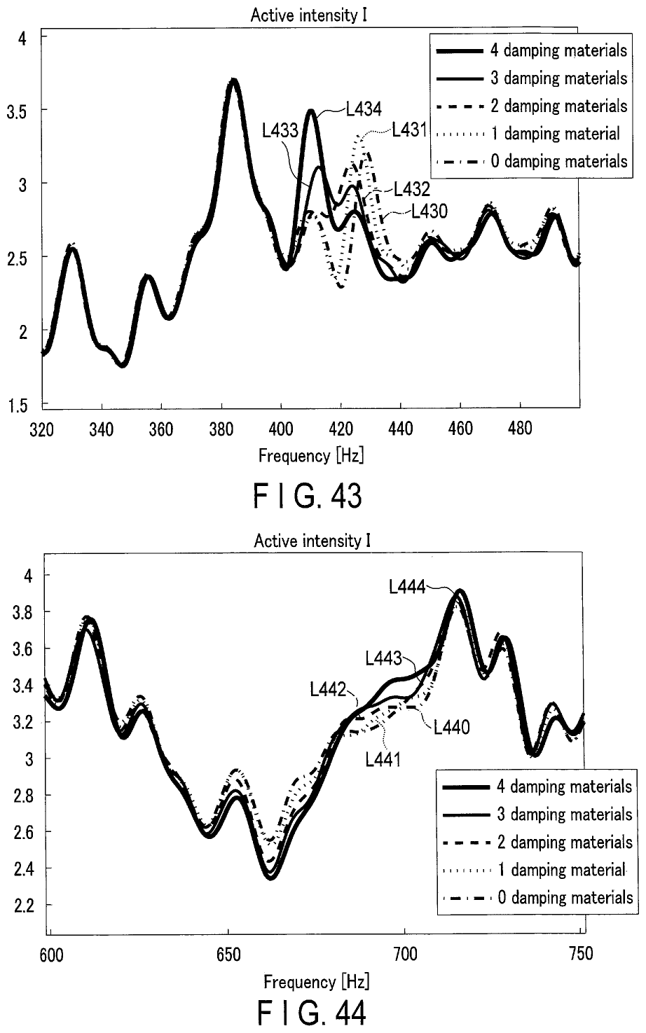

FIGS. 43, 44, 45, and 46 each show an evaluation result by two-microphone intensity evaluation 1.

FIG. 43 is a graph showing the evaluation result of the active intensity by two-microphone intensity evaluation 1 in a frequency band of 320 to 500 Hz. Lines L430, L431, L432, L433, and L434 represent the plots of the measurement results in the states in which the number of damping materials 361 to 364 is 0, 1, 2, 3, and 4.

FIG. 44 is a graph showing the evaluation result of the active intensity by two-microphone intensity evaluation 1 in a frequency band of 600 to 750 Hz. Lines L440, L441, L442, L443, and L444 represent the plots of the measurement results in the states in which the number of damping materials 361 to 364 is 0, 1, 2, 3, and 4.

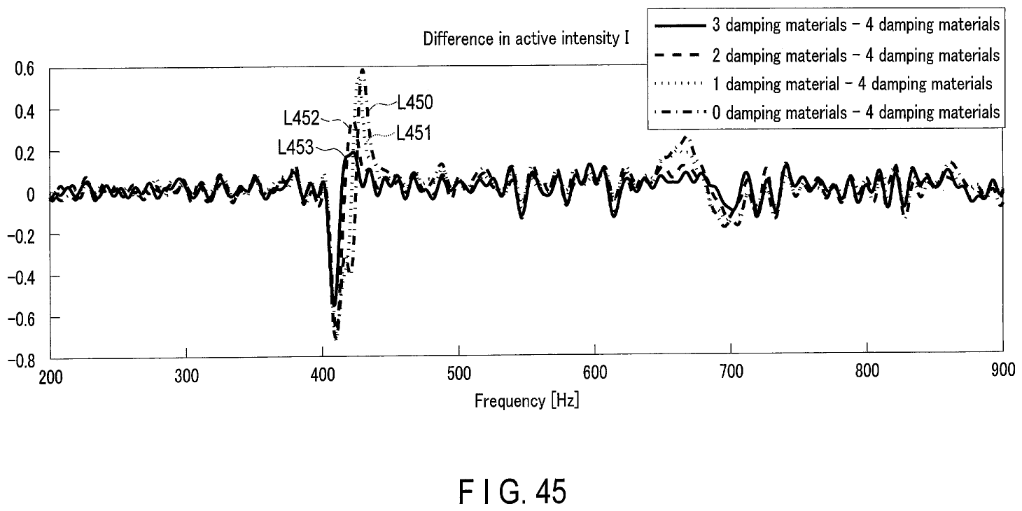

FIG. 45 is a graph showing the evaluation result of differences in active intensity I by two-microphone intensity evaluation 1. Lines L450, L451, L452, and L453 represent the plots of differences between the measurement result in the reference state in which the number of damping materials 361 to 364 is 4 and the measurement results in the states in which the number of damping materials 361 to 364 is 0, 1, 2, and 3.

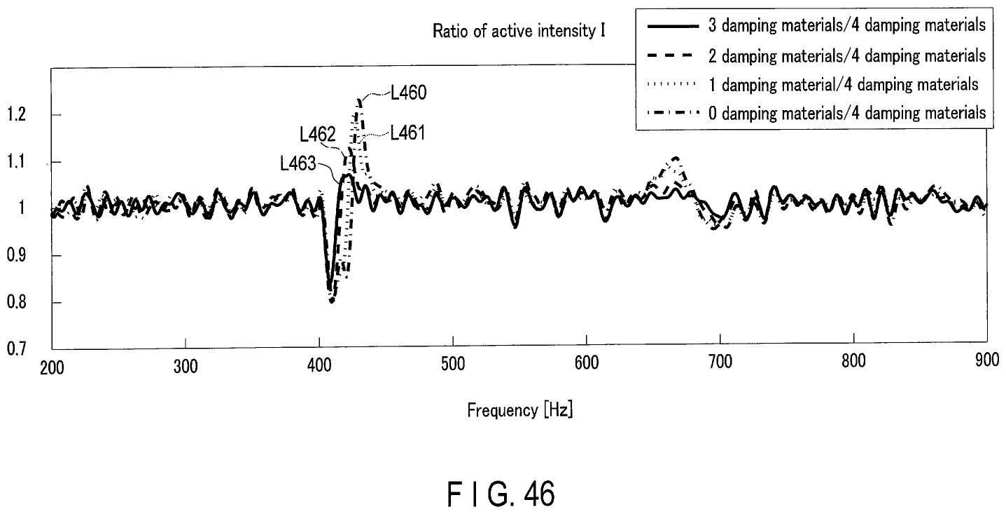

FIG. 46 is a graph showing the evaluation result of the ratios of the active intensity I by two-microphone intensity evaluation 1. Lines L460, L461, L462, and L463 represent the plots of the ratios of the measurement results in the states in which the number of damping materials 361 to 364 is 0, 1, 2, and 3 with respect to the measurement result in the reference state in which the number of damping materials 361 to 364 is 4.

In the graphs shown in FIGS. 45 and 46, it can be confirmed that in a frequency band of 400 to 450 Hz, the natural frequency fluctuates in the antiresonance/resonance shape due to peeling of the damping material, as described above. It can also be confirmed that in a frequency band of 650 to 700 Hz, the active intensity increases along with an increase in sound absorption characteristic caused by peeling of the damping material.

(Two-Microphone Intensity Evaluation 2)

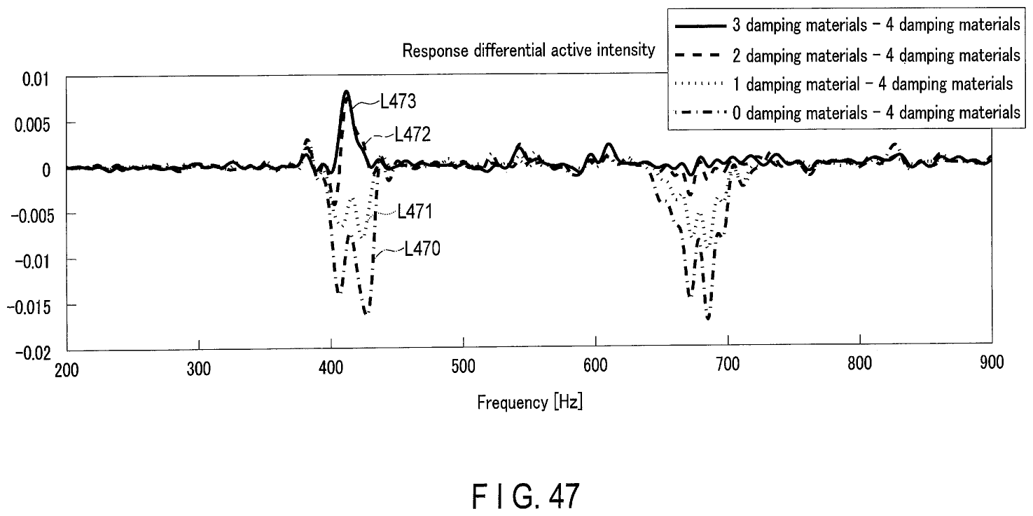

FIG. 47 shows an evaluation result by two-microphone intensity evaluation 2. FIG. 47 is a graph showing the evaluation result of response differential active intensities by two-microphone intensity evaluation 2. Lines L470, L471, L472, and L473 represent the plots of differences between the measurement result in the reference state in which the number of damping materials 361 to 364 is 4 and the measurement results in the states in which the number of damping materials 361 to 364 is 0, 1, 2, and 3.

In two-microphone intensity evaluation 2, there is no physical meaning of the positive and negative, unlike two-microphone intensity evaluation 1. In the graph shown in FIG. 47, however, a change caused by peeling of the damping material can similarly be confirmed in frequency bands of 400 to 450 Hz and 650 to 700 Hz.

### SUMMARY

In any of the four methods of single microphone frequency characteristic evaluation 1, single microphone frequency characteristic evaluation 2, two-microphone intensity evaluation 1, and two-microphone intensity evaluation 2, a result similar to that of LDV measurement is obtained, and these methods can be regarded as effective measurement and diagnostic methods that can perform measurement even in a case in which LDV measurement is difficult (a case in which the diagnosis target object does not appear outside like this example). Two-microphone intensity evaluation 1 can be regarded as an especially effective evaluation method since it is possible to reduce the influence of ambient reflection, and there are the positive and negative directions, thereby understanding the phenomenon of the change.

(Evaluation of Linear Characteristic in 1 KHz or More)

The linear characteristic in 1 KHz or more is evaluated by two-microphone intensity evaluation 1.

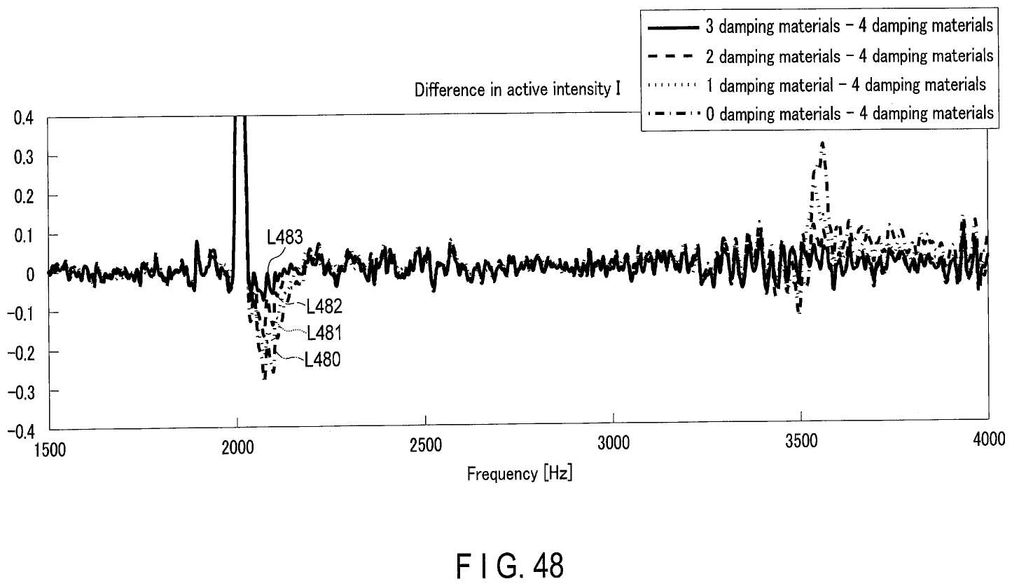

FIG. 48 is a graph showing the evaluation result of differences in the active intensity I by two-microphone intensity evaluation 1. Lines L480, L481, L482, and L483 represent the plots of differences between the measurement result in the reference state in which the number of damping materials 361 to 364 is 4 and the measurement results in the states in which the number of damping materials 361 to 364 is 0, 1, 2, and 3.

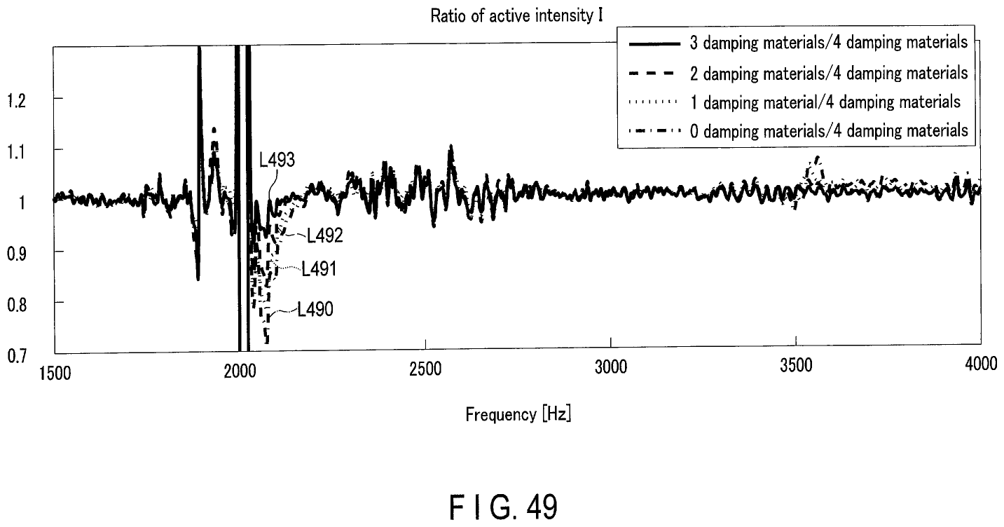

FIG. 49 is a graph showing the evaluation result of the ratios of the active intensity I by two-microphone intensity evaluation 1. Lines L490, L491, L492, and L493 represent the plots of the ratios of the measurement results in the states in which the number of damping materials 361 to 364 is 0, 1, 2, and 3 with respect to the measurement result in the reference state in which the number of damping materials 361 to 364 is 4.

In the graphs shown in FIGS. 48 and 49, in frequency bands of 2000 to 2200 Hz and 3400 to 3600 Hz, a change caused by peeling of the damping material can similarly be confirmed. More specifically, although the evaluation result of the single microphone is omitted, a change in characteristic in a frequency band around 3,500 Hz in which it is difficult to confirm a change by single microphone evaluation can be evaluated by two-microphone intensity evaluation 1, as shown in the graphs of FIGS. 48 and 49. A change in a frequency band around 2,000 Hz is a negative change, and can be considered to be caused by the increase of the vibration radiated sound caused by peeling of the damping material.

(Auxiliary Structure State Analysis)

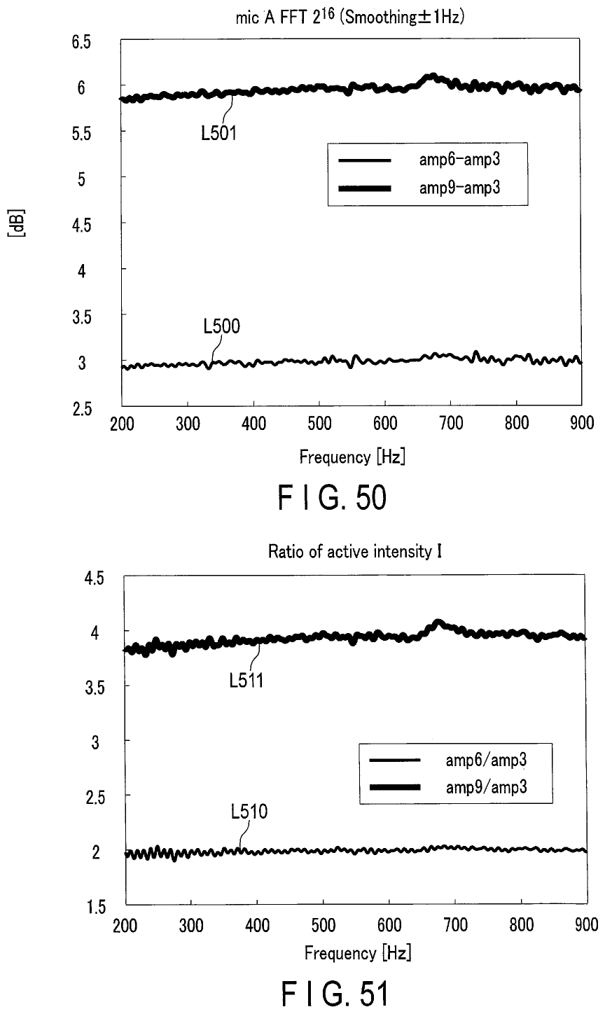

Subsequently, linear characteristic evaluation by auxiliary structure state analysis will be explained. FIGS. 50 and 51 each show only the evaluation result by single microphone frequency characteristic evaluation 1. The acoustic vibration sound volume was sequentially changed to +0 dB, +3 dB, +6 dB, and +9 dB. The second microphone (mic A) was used for acoustic measurement.

FIG. 50 is a graph showing the evaluation result of a difference transfer characteristic by single microphone frequency characteristic evaluation 1. Lines L500 and L501 represent the plots of differences between the measurement result in the case of +3 dB and the measurement results in the cases of +6 dB and +9 dB.

FIG. 51 is a graph showing the evaluation result of the ratios of the active intensity I by two-microphone intensity evaluation 1. Lines L510 and L511 represent the plots of the ratios of the measurement results in the cases of +6 dB and +9 dB with respect to the measurement result in the case of +3 dB.

When the acoustic sound volume is increased to 3 dB and 6 dB, it can be confirmed in the graph shown in FIG. 50 that the microphone acquisition sound pressure increases accordingly, and it can be confirmed in the graph shown in FIG. 51 that the active intensity (a change of square times of an amplitude change because of energy) increases twofold and fourfold, thereby confirming that there is no problem in the measurement environment. If the change deviates from such change, there is a problem in the measurement environment, and it is thus necessary to take measures such as sound absorption processing in the measurement environment.

(Evaluation of Nonlinear Characteristic in 1 KHz or More)

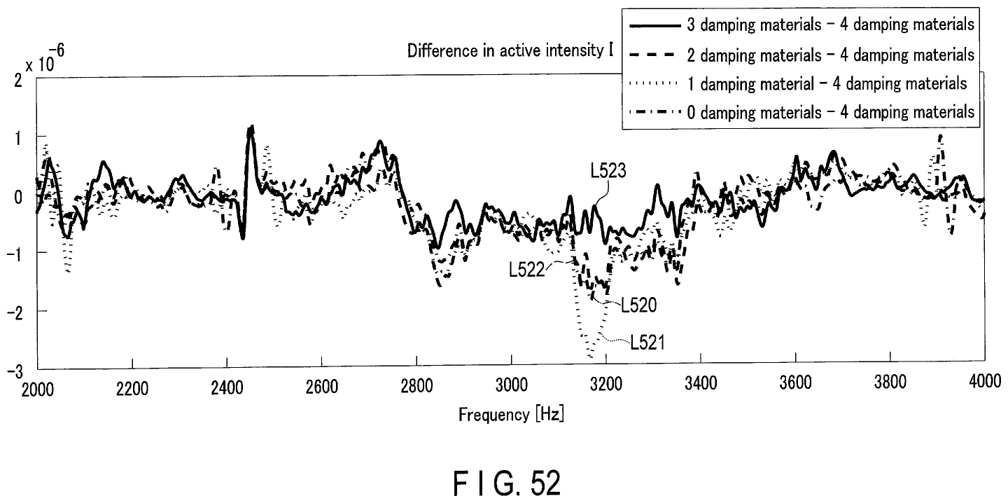

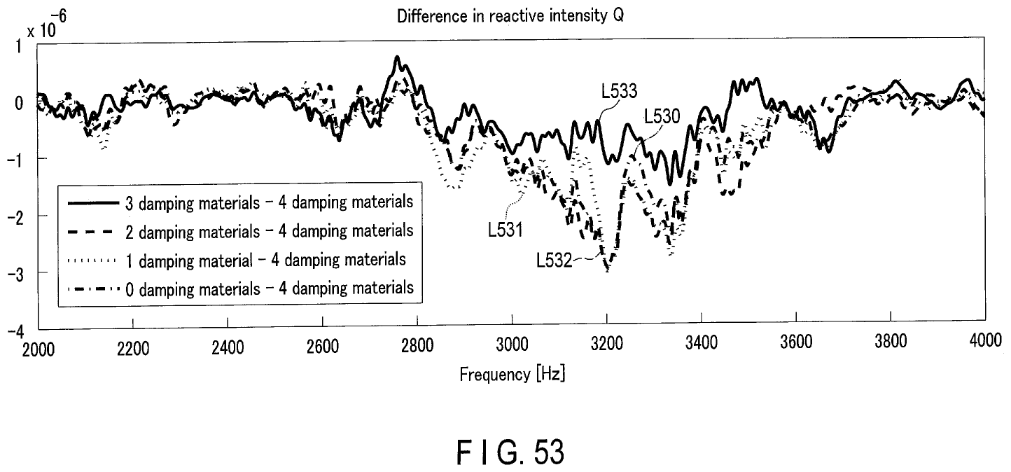

Next, evaluation of the nonlinear characteristic (first-order distortion characteristic) in 1 KHz or more will be explained. FIGS. 52 and 53 each show only the evaluation result by two-microphone intensity evaluation 1.

FIG. 52 is a graph showing the evaluation result of differences in active intensity I by two-microphone intensity evaluation 1. Lines L520, L521, L522, and L523 represent the plots of differences between the measurement result in the reference state in which the number of damping materials 361 to 364 is 4 and the measurement results in the states in which the number of damping materials 361 to 364 is 0, 1, 2, and 3.

FIG. 53 is a graph showing the evaluation result of differences in reactive intensity Q by two-microphone intensity evaluation 1. Lines L530, L531, L532, and L533 represent the plots of differences between the measurement result in the reference state in which the number of damping materials 361 to 364 is 4 and the measurement results in the states in which the number of damping materials 361 to 364 is 0, 1, 2, and 3.

In the graphs shown in FIGS. 52 and 53, in a frequency band of 3 to 3.4 KHz, a change in distortion characteristic caused by peeling of the damping material can be confirmed. Since a change in distortion characteristic corresponds to a change in nonlinear vibration radiated sound, if a “chatter vibration” becomes large, the active intensity decreases (because the positive direction of measurement of the intensity is a direction toward the diagnosis target object 90). If the Logss signal is adopted as an acoustic vibration signal, such evaluation of the distortion characteristic is possible, and a change such as a change in sound absorption coefficient or linear vibration radiated sound other than a change in linear characteristic can be used for evaluation of a sign of deterioration.

Like this measurement, a change in reactive intensity may be conspicuous more than active intensity. Thus, both the active intensity and the reactive intensity are effectively monitored. Note that this frequency band is a frequency band in which a change can be confirmed although the level is low even in LDV measurement (although linear measurement).

(Auxiliary Structure State Analysis)

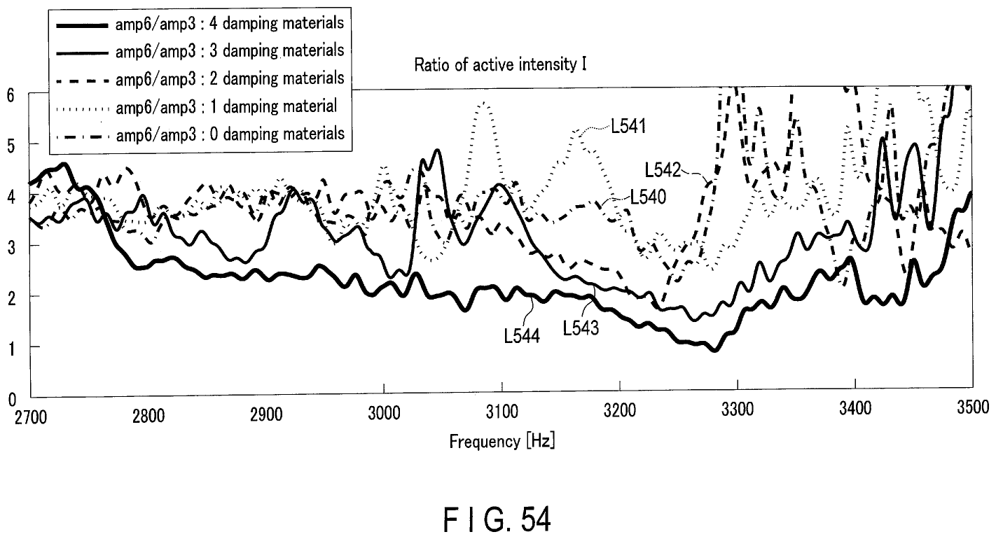

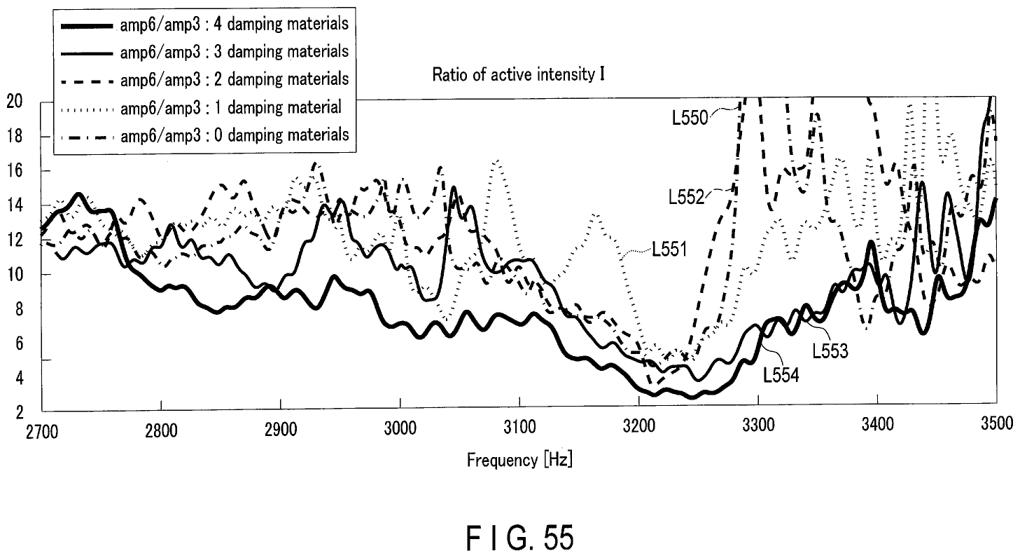

Subsequently, evaluation of the nonlinear characteristic (first-order distortion characteristic) in 1 KHz or more by auxiliary structure state analysis will be explained. FIGS. 54 and 55 each show only the evaluation result by two-microphone intensity evaluation 1. The acoustic vibration sound volume was sequentially changed to +0 dB, +3 dB, +6 dB, and +9 dB. In single microphone frequency characteristic evaluation 1, the second microphone (mic A) was used for acoustic measurement.

FIG. 54 is a graph showing the evaluation result of the ratios of the active intensity I at a sound pressure ratio of 6 dB/3 dB by two-microphone intensity evaluation 1. Lines L540, L541, L542, L543, and L544 represent the plots of the measurement results in the states in which the number of damping materials 361 to 364 is 0, 1, 2, 3, and 4.

FIG. 55 is a graph showing the evaluation result of the ratios of the active intensity I at a sound pressure ratio of 9 dB/3 dB by two-microphone intensity evaluation 1. Lines L550, L551, L552, L553, and L554 represent the plots of the measurement results in the states in which the number of damping materials 361 to 364 is 0, 1, 2, 3, and 4.

Because of the distortion characteristic, the characteristic does not change linearly, as a matter of course. Since, however, a change occurs in the measurement state in a frequency band of 3 to 3.4 KHz, it is possible to diagnose a change in distortion characteristic by monitoring a change in the state of the intensity ratio caused by the change of the sound volume.

(Diagnostic Processing Based on Another Analysis Method)

Next, diagnostic processing executed by the diagnostic processing unit 30 based on another analysis method different from the above-described four kinds of analysis methods will be described. In the diagnostic processing based on the other analysis method, the structure state analysis unit 32 calculates the sound pressure of the sound wave coming from the direction of the diagnosis target object, the intensity, and the sound absorption coefficient, and the structure state diagnostic unit 33 evaluates changes in these acoustic characteristics, thereby determining deterioration of the structure.

An overview of the other analysis method will be described. The two nondirectional microphones 21 and 22 separate the sound waves coming from the rear side (incident side) and front side (opposite side) of the microphones 21 and 22, and especially analyzes the sound wave from the front side (the direction of the diagnosis target object). Furthermore, each of the separated intensities on the front and rear sides is obtained and an approximate sound absorption coefficient is obtained and used for deterioration evaluation. The separation method shifts two impulse responses and performs subtraction of them, thereby implementing separation. The microphones installed close to each other need not use correlation processing, and can perform separation by shifting the impulse responses forward and backward from the propagation time of the distance between the microphones although the frequency weight is applied. The frequency weight will be corrected later.

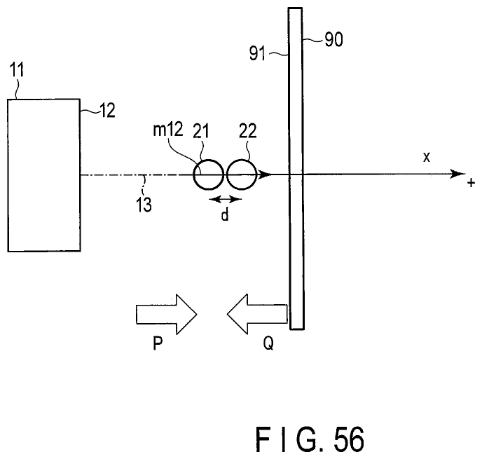

The arrangement relationship among the speaker 11, the first microphone 21, the second microphone 22, and the diagnosis target object 90 will be described next with reference to FIG. 56. FIG. 56 is a view showing the arrangement relationship among the speaker 11, the first microphone 21, the second microphone 22, and the diagnosis target object 90.

Both the first microphone 21 and the second microphone 22 are nondirectional microphones. The first microphone 21 and the second microphone 22 are located at the distance d on the speaker axis 13 of the speaker 11. The speaker axis 13 is perpendicular to the plane of the diagnosis target object 90. The positive direction of the measurement axis m12 passing through the first microphone 21 and the second microphone 22 is the direction toward the diagnosis target object 90.

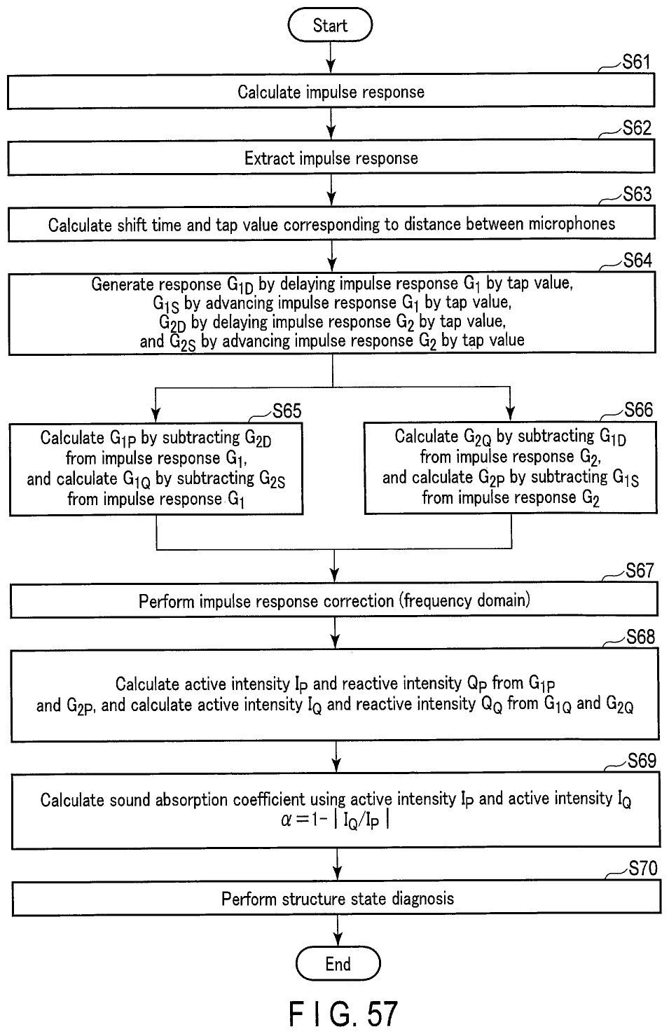

The diagnostic processing based on the other analysis method different from the analysis method shown in FIGS. 8, 9, 10, and 11 will be described with reference to FIG. 57. FIG. 57 is a flowchart illustrating the processing procedure of the diagnostic processing based on the other analysis method.

In step S61, the impulse response calculation unit 31 receives a sound reception signal from each of the first microphone 21 and the second microphone 22, and calculates the impulse response of each of the first microphone 21 and the second microphone 22. In this example, the speaker 11 applies an acoustic vibration by continuously inputting a TSP signal such as a Logss signal.

In step S62, the structure state analysis unit 32 extracts waveforms in a linear characteristic section and respective distortion characteristic sections from each impulse response. The structure state analysis unit 32 executes subsequent processes except for structure state diagnosis as the last process. In this analysis method, the sound absorption coefficient is calculated in addition to the transfer characteristic and intensity. In this example, since the Logss signal is used as an acoustic vibration signal, the impulse response extraction processing in step S62 is performed. If, however, a TSP signal other than the Logss signal is used as an acoustic vibration signal, the impulse response extraction processing in step S62 is skipped. Evaluation of the sound absorption coefficient is evaluation of only the linear characteristic section that has a physical meaning. Note that with respect to the transfer characteristic and intensity, if the Logss signal is used, each distortion characteristic section can similarly be evaluated in addition to the linear characteristic section.

In step S63, a shift time and a tap value corresponding to the distance d between the first microphone 21 and the second microphone 22 are calculated in accordance with equations (13) below. In equations (13), c represents the speed of sound and fₛ represents the sampling frequency.

time_{shift}=d/c, tap_{shift}=time_{shift}×fₛ (13)

In step S64, the following processing is performed with respect to an impulse response G₁(t) of the first microphone 21 and an impulse response G₂(t) of the second microphone 22.

A response G_{1D}(t) is generated by delaying the impulse response G₁(t) by the tap value.

A response G_{1S}(t) is generated by advancing the impulse response G₁(t) by the tap value.

A response G_{2D}(t) is generated by delaying the impulse response G₂(t) by the tap value.

A response G_{2S}(t) is generated by advancing the impulse response G₂(t) by the tap value.

In step S65, impulse response shift differences G_{1P}(t) and G_{1Q}(t) are calculated by the following processing. A subscript. P indicates a direction from the first microphone 21 to the second microphone 22, and a subscript Q indicates a direction from the second microphone 22 to the first microphone 21.

G_{1P}(t) is calculated by subtracting G_{2D}(t) from the impulse response G₁(t).

G_{1Q}(t) is calculated by subtracting G_{2S}(t) from the impulse response G₁(t).

In step S66, impulse response shift differences G_{2Q}(t) and G_{2P}(t) are calculated by the following processing.

G_{2Q}(t) is calculated by subtracting G_{1D}(t) from the impulse response G₂(t).

G_{2P}(t) is calculated by subtracting G_{1S}(t) from the impulse response G₂(t).

In step S67, impulse response correction (frequency domain) is performed in accordance with equations (14) below.

$$\frac{{G}_{1 P} ( ω )}{1 - {D}^{2} ( ω )} \to {G}_{1 P} ( ω ) \qquad ( 14 )$$

$$\frac{{G}_{1 Q} ( ω )}{1 - {S}^{2} ( ω )} \to {G}_{1 Q} ( ω )$$

$$\frac{{G}_{2 Q} ( ω )}{1 - {D}^{2} ( ω )} \to {G}_{2 Q} ( ω )$$

$$\frac{{G}_{2 P} ( ω )}{1 - {S}^{2} ( ω )} \to {G}_{2 P} ( ω )$$

$$D ( ω ) = exp ( - j ω \times {tap}_{shift} / {f}_{s} )$$

$$S ( ω ) = exp ( j ω \times {tap}_{shift} / {f}_{s} )$$

where “→” means that the transfer characteristic on the left side (before the arrow) is replaced by the transfer characteristic on the right side (after the arrow). The processing in step S67 is processing for obtaining the correct intensity value and the correct value of the sound absorption coefficient. However, this embodiment mainly aims at not obtaining the correct intensity value and the correct value of the sound absorption coefficient but evaluating the differences from the reference state. Therefore, the processing in step S67 may be skipped.

Next, in step S68, the following processing is performed.

Active intensity I_{P}(ω) and reactive intensity Q_{P}(ω) are calculated from G_{1P}(ω) and G_{2P}(ω)).

Active intensity I_{Q}(ω) and reactive intensity Q_{Q}(ω) are calculated from G_{1Q}(ω) and G_{2Q}(ω).

In step S69, a sound absorption coefficient α(ω) is calculated using the active intensity I_{P}(ω)) and the active intensity I_{Q}(ω) by α(ω)=1−|I_{Q}(ω)/I_{P}(ω)|.

This completes the analysis processing by the structure state analysis unit 32.

Finally, in step S70, the structure state diagnostic unit 33 determines deterioration of the structure by evaluating changes in acoustic characteristics. That is, changes in the active intensity I_{P}(ω), reactive intensity Q_{P}(ω), active intensity I_{Q}(ω), reactive intensity Q_{Q}(ω), and α(ω) are evaluated, thereby determining deterioration of the structure.

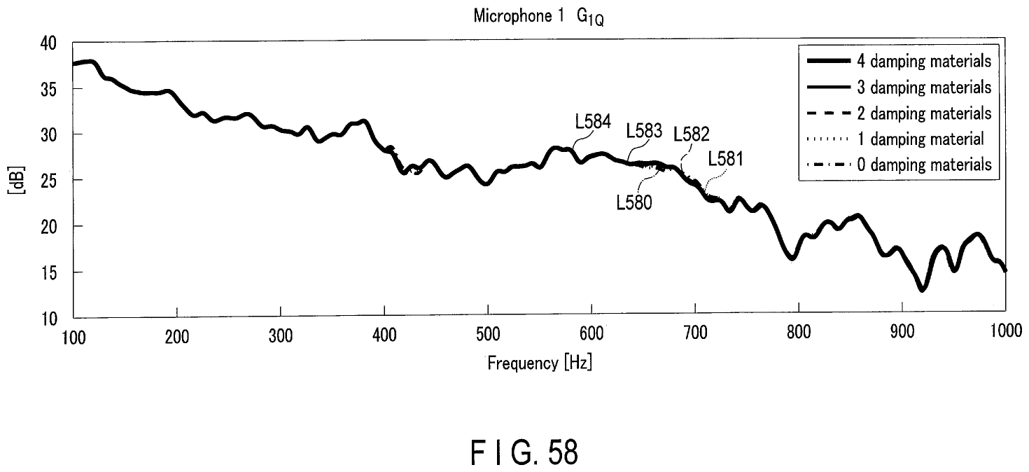

The evaluation result obtained by applying the analysis method under the above-described conditions of the example will be described below. First, FIGS. 58, 59, 60, and 61 each show the evaluation result of the transfer characteristic of the sound wave coming from the diagnosis target object 90 and obtained using the first microphone 21.

FIG. 58 is a graph showing the evaluation result of the transfer characteristic in a frequency band of 1 KHz or less. Lines L580, L581, L582, L583, and L584 represent the plots of the measurement results in the states in which the number of damping materials 361 to 364 is 0, 1, 2, 3, and 4.

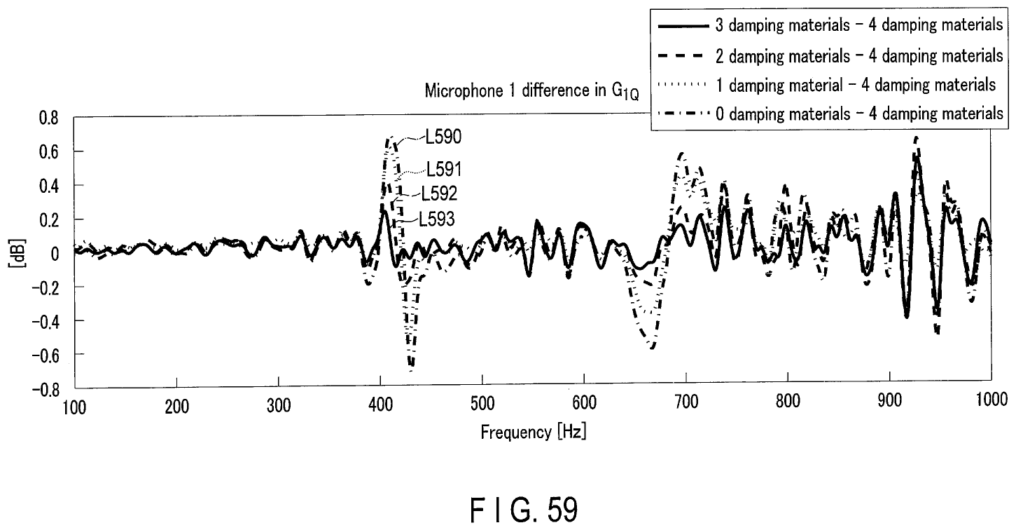

FIG. 59 is a graph showing the evaluation result of the difference transfer characteristic in a frequency band of 1 KHz or less. Lines L590, L591, L592, and L593 represent the plots of differences between the measurement result in the reference state in which the number of damping materials 361 to 364 is 4 and the measurement results in the states in which the number of damping materials 361 to 364 is 0, 1, 2, and 3.

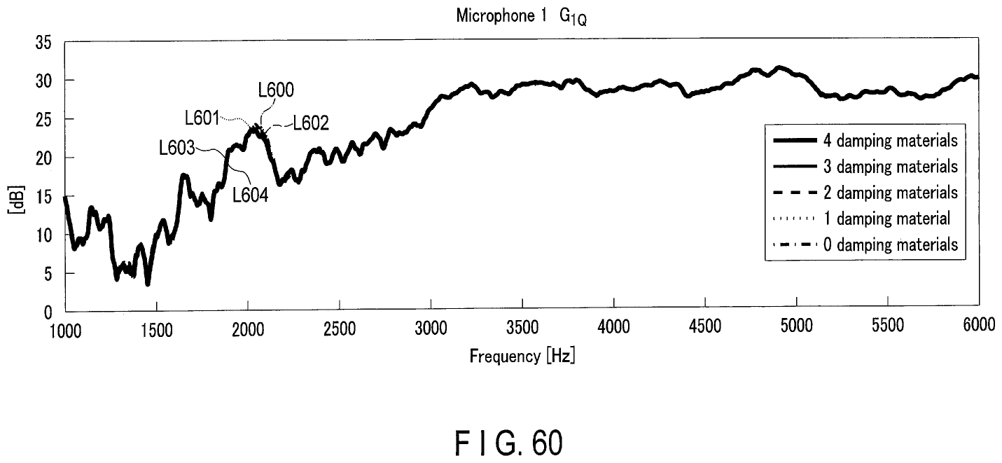

FIG. 60 is a graph showing the evaluation result of the transfer characteristic in a frequency band of 1 KHz or more. Lines L600, L601, L602, L603, and L604 represent the plots of the measurement results in the states in which the number of damping materials 361 to 364 is 0, 1, 2, 3, and 4.

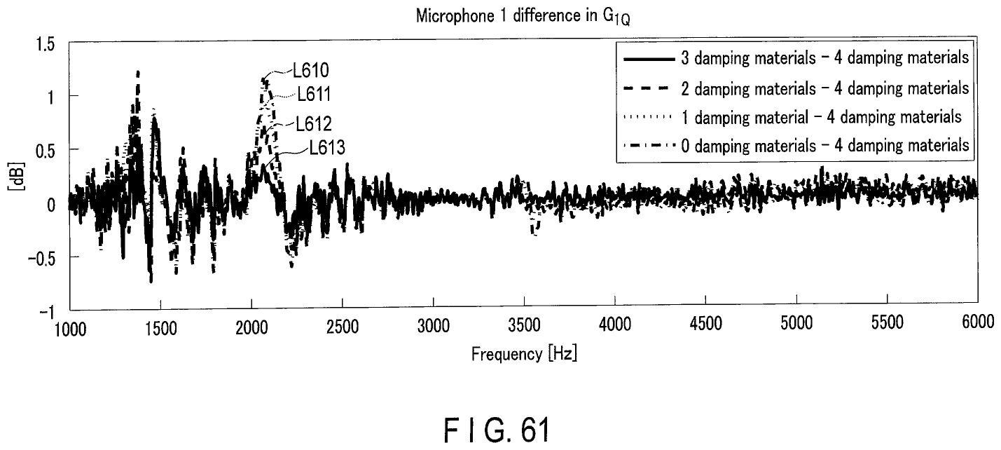

FIG. 61 is a graph showing the evaluation result of the difference transfer characteristic in a frequency band of 1 KHz or more. Lines L610, L611, L612, and L613 represent the plots of differences between the measurement result in the reference state in which the number of damping materials 361 to 364 is 4 and the measurement results in the states in which the number of damping materials 361 to 364 is 0, 1, 2, and 3.

It is found from the evaluation results of the difference transfer characteristic shown in FIGS. 59 and 61 that the influence of peeling of the damping material can accurately be grasped in frequency bands of 400 to 450 Hz, 650 to 750 Hz, 1,300 to 1,500 Hz, 2,000 to 2,200 Hz, and 3,400 to 3,600 Hz. In particular, a change around 1,500 Hz that cannot be determined in the above-described analysis method can be grasped.

Characteristic evaluation of the sound wave coming from the diagnosis target object 90 and obtained using the second microphone 22 gives the same result as that of characteristic evaluation of the sound wave coming from the diagnosis target object 90 and obtained using the first microphone 21.

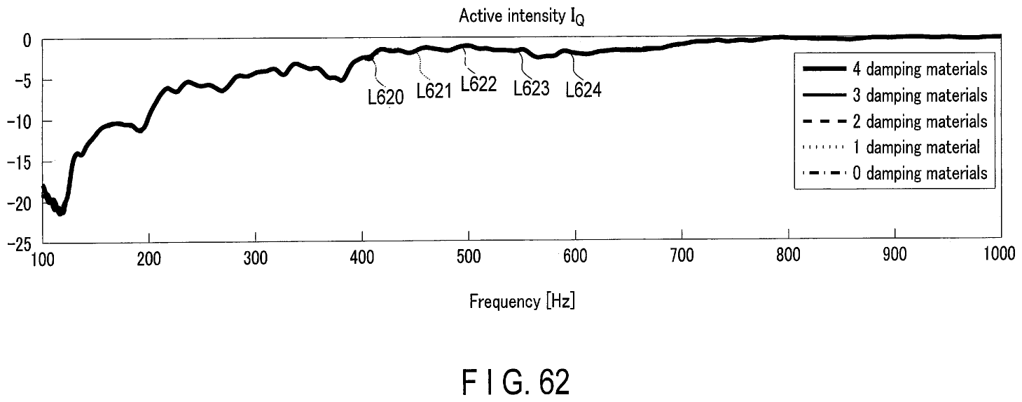

FIGS. 62, 63, 64, and 65 each show characteristic evaluation of intensity coming from the diagnosis target object 90.

FIG. 62 is a graph showing the evaluation result of the active intensity I_{Q} in a frequency band of 1 KHz or less. Lines L620, L621, L622, L623, and L624 represent the plots of the measurement results in the states in which the number of damping materials 361 to 364 is 0, 1, 2, 3, and 4.

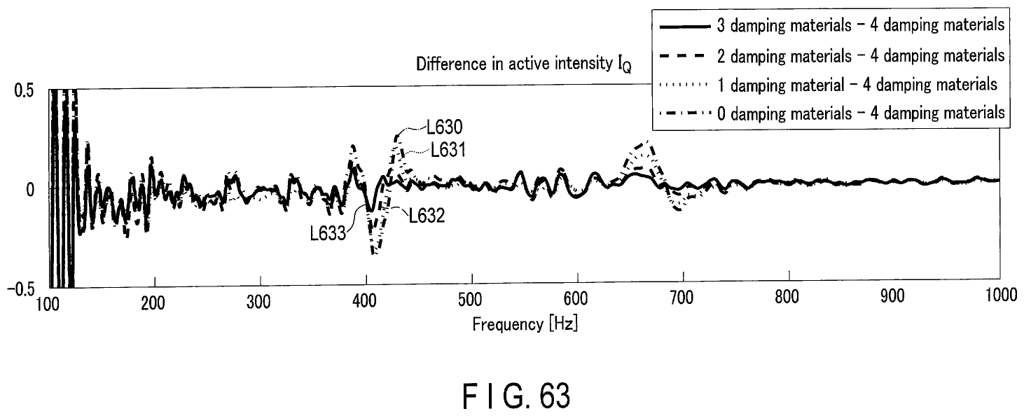

FIG. 63 is a graph showing the evaluation result of differences in the active intensity I_{Q} in a frequency band of 1 KHz or less. Lines L630, L631, L632, and L633 represent the plots of differences between the measurement result in the reference state in which the number of damping materials 361 to 364 is 4 and the measurement results in the states in which the number of damping materials 361 to 364 is 0, 1, 2, and 3.

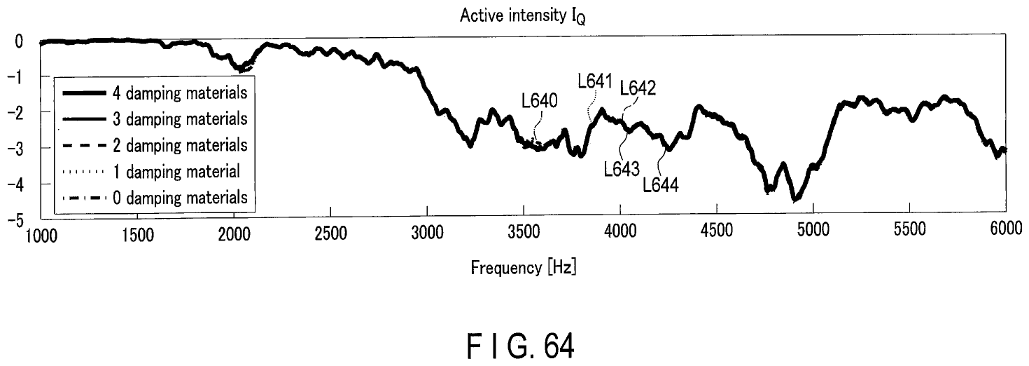

FIG. 64 is a graph showing the evaluation result of the active intensity I_{Q} in a frequency band of 1 KHz or more. Lines L640, L641, L642, L643, and L644 represent the plots of the measurement results in the states in which the number of damping materials 361 to 364 is 0, 1, 2, 3, and 4.

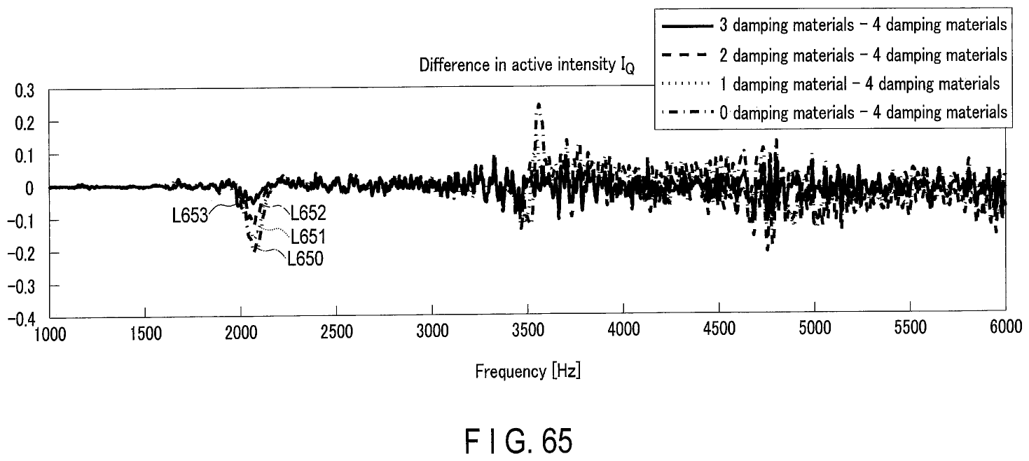

FIG. 65 is a graph showing the evaluation result of the differences in the active intensity I_{Q} in a frequency band of 1 KHz or more. Lines L650, L651, L652, and L653 represent the plots of differences between the measurement result in the reference state in which the number of damping materials 361 to 364 is 4 and the measurement results in the states in which the number of damping materials 361 to 364 is 0, 1, 2, and 3.

It is found from the evaluation results of the differences in the active intensity I_{Q} shown in FIGS. 63 and 65 that the influence of peeling of the damping material can accurately be grasped in frequency bands of 400 to 450 Hz, 650 to 700 Hz, 2000 to 2200 Hz, and 3400 to 3600 Hz, similar to the evaluation results of the differences in the active intensity I shown in FIGS. 45 and 48.

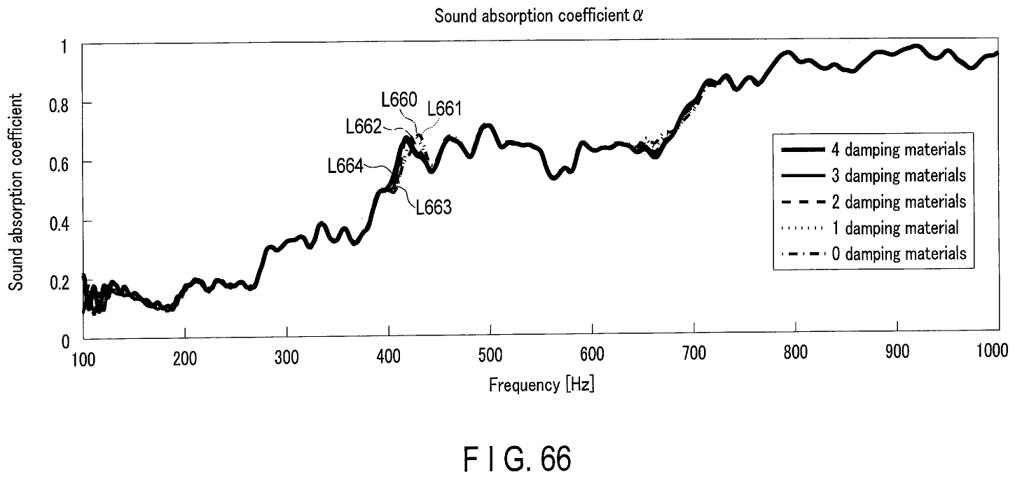

Finally, FIGS. 66, 67, 68, and 69 each show characteristic evaluation of the sound absorption coefficient as the feature of the analysis method.

FIG. 66 is a graph showing the evaluation result of a sound absorption coefficient α in a frequency band of 1 KHz or less. Lines L660, L661, L662, L663, and L664 represent the plots of the measurement results in the states in which the number of damping materials 361 to 364 is 0, 1, 2, 3, and 4.

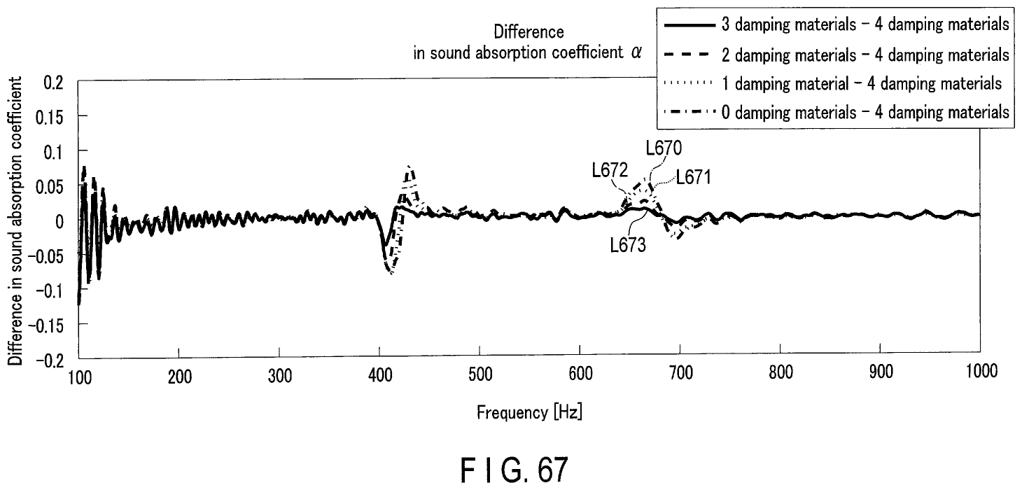

FIG. 67 is a graph showing the evaluation result of differences in the sound absorption coefficient α in a frequency band of 1 KHz or less. Lines L670, L671, L672, and L673 represent the plots of differences between the measurement result in the reference state in which the number of damping materials 361 to 364 is 4 and the measurement results in the states in which the number of damping materials 361 to 364 is 0, 1, 2, and 3.

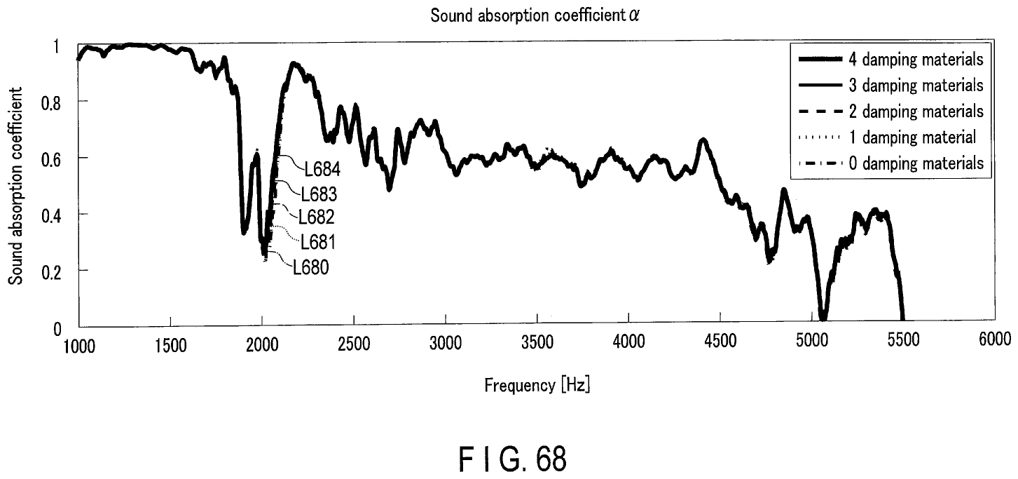

FIG. 68 is a graph showing the evaluation result of the sound absorption coefficient α in a frequency band of 1 KHz or more. Lines L680, L681, L682, L683, and L684 represent the plots of the measurement results in the states in which the number of damping materials 361 to 364 is 0, 1, 2, 3, and 4.

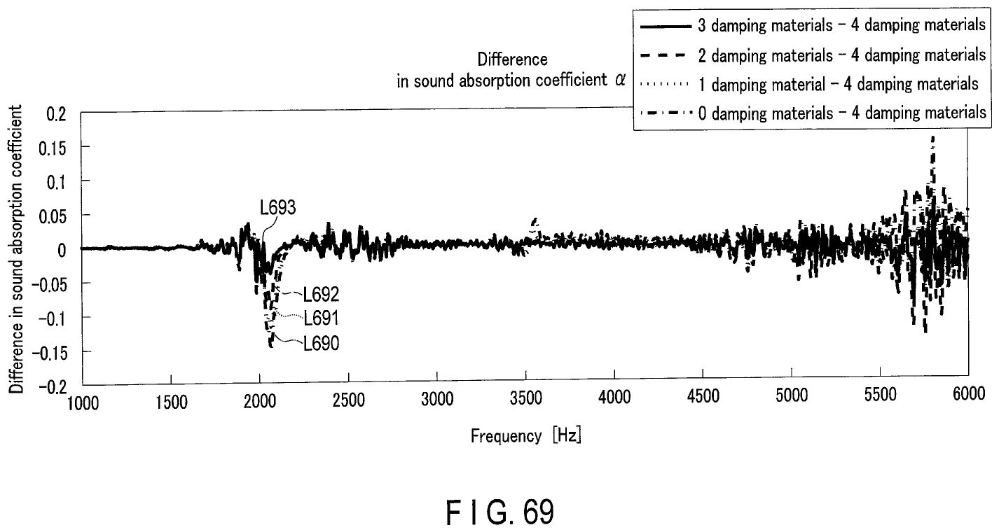

FIG. 69 is a graph showing the evaluation result of differences in the sound absorption coefficient α in a frequency band of 1 KHz or more. Lines L690, L691, L692, and L693 represent the plots of differences between the measurement result in the reference state in which the number of damping materials 361 to 364 is 4 and the measurement results in the states in which the number of damping materials 361 to 364 is 0, 1, 2, and 3.

In the graphs shown in FIGS. 67 and 69, the influence of peeling of the damping material appears in frequency bands of 400 to 450 Hz, 650 to 700 Hz, 2000 to 2200 Hz, and 3400 to 3600 Hz. That is, it can be confirmed from evaluation of the sound absorption coefficient α that peeling of the damping material can appropriately be evaluated. Note that the sound absorption coefficient α is an acoustic characteristic having a value of 0 to 1, and has the feature that it becomes easy to create the baseline of deterioration, as compared with the intensity and the sound pressure as other acoustic characteristic indices.

Note that it is effective for monitoring to measure the distance between the diagnosis target object 90 and the microphones 21 and 22 in some cases.

According to the embodiment or the example, it is possible to provide an acoustic diagnostic apparatus that diagnoses, in a contactless manner, a diagnosis target object by applying an acoustic vibration to the diagnosis target object.

In the embodiment and the example, the diagnosis target object having the plane has been exemplified. However, the acoustic diagnostic apparatus according to the embodiment or the example is also applicable to a diagnosis target object having a curved shape such as a columnar shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic diagnostic apparatus comprising:
an acoustic vibration unit configured to apply an acoustic vibration to a diagnosis target object;
an acoustic vibration signal generation unit configured to generate an acoustic vibration signal and continuously input the acoustic vibration signal to the acoustic vibration unit;
a sound receiving unit configured to receive an evaluation target sound including a sound wave reflected from the diagnosis target object and a vibration radiated sound from the diagnosis target object, and output a sound reception signal;
an impulse response calculation unit configured to calculate an impulse response based on the sound reception signal;
a structure state analysis unit configured to calculate an acoustic characteristic using the impulse response, and analyze a state of the diagnosis target object by grasping a change of the sound reception signal; and
a structure state diagnostic unit configured to diagnose the state of the diagnosis target object based on an analysis result of the structure state analysis unit.

2. The acoustic diagnostic apparatus according to claim 1, wherein the acoustic vibration unit includes one of a single speaker, a directional single sound source having directivity improved by attaching an acoustic cylinder to a single speaker, a speaker group in which a plurality of speakers are arranged on a circumference to be in-phase driven, a speaker group in which a plurality of speakers are arranged on a grid to simulatively output plane waves, and a general-purpose flat speaker.

3. The acoustic diagnostic apparatus according to claim 1, wherein the sound receiving unit includes two microphones, each of the two microphones is one of a nondirectional microphone, a directional microphone, a shotgun microphone, a line array microphone, and a circular array microphone, and the two microphones are both nondirectional microphones or directional microphones.

4. The acoustic diagnostic apparatus according to claim 1, wherein the acoustic vibration unit is installed so that a front surface emitting a sound wave faces the diagnosis target object, the sound receiving unit includes two microphones, and the two microphones are arranged on a line segment connecting the acoustic vibration unit and the diagnosis target object.

5. The acoustic diagnostic apparatus according to claim 1, wherein
the acoustic vibration signal generation unit continuously inputs, to the acoustic vibration unit, a Logss signal capable of separating a nonlinear characteristic, and
the structure state analysis unit
extracts, in a first step, waveforms in a linear characteristic section and respective distortion characteristic sections from the impulse response calculated by the impulse response calculation unit, and
performs, in a second step, single microphone frequency characteristic evaluation 1, single microphone frequency characteristic evaluation 2, two-microphone intensity evaluation 1, and two-microphone intensity evaluation 2.

6. The acoustic diagnostic apparatus according to claim 5, wherein in the single microphone frequency characteristic evaluation 1, the structure state analysis unit
appends, in a first step, 0 to an extracted impulse response of a single microphone to have a signal length equal to a signal length before extraction, and executes FFT for the thus obtained impulse response,
performs, in a second step, frequency characteristic smoothing for a gain characteristic and a phase characteristic, and
displays, in a third step, comparison of a transfer characteristic with a reference state.

7. The acoustic diagnostic apparatus according to claim 5, wherein in the single microphone frequency characteristic evaluation 2, the structure state analysis unit
calculates, in a first step, a difference between a reference measurement extracted impulse response measured in a reference state and an extracted impulse response of a single microphone,
appends, in a second step, 0 to the extracted difference impulse response to have a signal length equal to a signal length before extraction, and executes FFT for the thus obtained difference impulse response,
performs, in a third step, frequency characteristic smoothing for a gain characteristic and a phase characteristic, and
displays a difference transfer characteristic in a fourth step.

8. The acoustic diagnostic apparatus according to claim 5, wherein in the two-microphone intensity evaluation 1, the structure state analysis unit
appends, in a first step, 0 to an extracted impulse response of each of two microphones to have a signal length equal to a signal length before extraction, and executes FFT for the thus obtained impulse response,
performs, in a second step, frequency characteristic smoothing for a gain characteristic and a phase characteristic, and calculates active intensity and reactive intensity using smoothed FFT values, and
displays, in a third step, comparison of an intensity characteristic with a reference state.

9. The acoustic diagnostic apparatus according to claim 5, wherein in the two-microphone intensity evaluation 2, the structure state analysis unit
calculates, in a first step, a difference between a reference measurement extracted impulse response measured in a reference state and an extracted impulse response of each of two microphones,
appends, in a second step, 0 to an extracted difference impulse response of each of the two microphones to have a signal length equal to a signal length before extraction, and executes FFT for the thus obtained difference impulse response of each of the two microphones,
performs, in a third step, frequency characteristic smoothing for a gain characteristic and a phase characteristic, and calculates active intensity and reactive intensity using smoothed FFT values, and
displays the active intensity and the reactive intensity in a fourth step.

10. The acoustic diagnostic apparatus according to claim 5, wherein as auxiliary structure state analysis, the structure state analysis unit performs measurement in a plurality of acoustic vibration sound volume patterns, sets an acoustic vibration sound volume of +0 dB as a reference state, displays one of a difference characteristic of the single microphone frequency characteristic evaluation 1 and a ratio characteristic of the two-microphone intensity evaluation 1 for each sound volume, confirms a linear change in evaluation of the linear characteristic section, determines, if the change deviates, that there is a problem in a measurement environment, and can assist diagnosis of deterioration by monitoring a change in characteristic in each state since no linear change is obtained in a nonlinear characteristic section (distortion characteristic).

11. The acoustic diagnostic apparatus according to claim 1, wherein
the acoustic vibration signal generation unit continuously inputs a TSP signal to the acoustic vibration unit, and
the structure state analysis unit performs single microphone frequency characteristic evaluation 1, single microphone frequency characteristic evaluation 2, two-microphone intensity evaluation 1, and two-microphone intensity evaluation 2 for the impulse response calculated by the impulse response calculation unit.

12. The acoustic diagnostic apparatus according to claim 1, wherein
the acoustic vibration signal generation unit continuously inputs, to the acoustic vibration unit, a Logss signal capable of separating a nonlinear characteristic, and
the structure state analysis unit
extracts, in a first step, waveforms in a linear characteristic section and respective distortion characteristic sections from the impulse response calculated by the impulse response calculation unit, and
performs, in a second step, single microphone frequency characteristic evaluation 1, single microphone frequency characteristic evaluation 2, two-microphone intensity evaluation 1, and two-microphone intensity evaluation 2 using the extracted waveforms.

13. The acoustic diagnostic apparatus according to claim 1, wherein the structure state diagnostic unit compares measurement analysis data obtained by the structure state analysis unit with a baseline of an allowable range measured and defined in advance at a time of occurrence of a failure mode, and determines an abnormal state when the measurement analysis data exceeds the baseline.

14. The acoustic diagnostic apparatus according to claim 1, wherein the structure state diagnostic unit determines, by monitoring time-series changes, whether measurement analysis data obtained by the structure state analysis unit tends to increase or decrease, and diagnoses progress of deterioration caused by a change over time.

15. The acoustic diagnostic apparatus according to claim 1, wherein if intensity with a positive direction toward the diagnosis target object increases, the structure state diagnostic unit diagnoses peeling of a damping material adhered to the diagnosis target object.

16. The acoustic diagnostic apparatus according to claim 1, wherein
the sound receiving unit includes a first microphone located between the acoustic vibration unit and the diagnosis target object, and a second microphone located between the first microphone and the diagnosis target object,
the acoustic vibration signal is a Logss signal capable of separating a nonlinear characteristic, and
the structure state analysis unit
extracts, in a first step, waveforms in a linear characteristic section and respective distortion characteristic sections from the impulse response calculated by the impulse response calculation unit,
calculates, in a second step, a shift time and a tap value corresponding to a distance between the first microphone and the second microphone,
generates, in a third step, with respect to an impulse response G₁(t) of the first microphone and an impulse response G₂(t) of the second microphone,
a response G_{1D}(t) by delaying the impulse response G₁(t) by the tap value,
a response G_{1S}(t) by advancing the impulse response G₁(t) by the tap value,
a response G_{2D}(t) by delaying the impulse response G₂(t) by the tap value, and
a response G_{2S}(t) by advancing the impulse response G₂(t) by the tap value,
calculates, in a fourth step, impulse response shift differences G_{1P}(t) G_{1Q}(t) G_{2Q}(t), and G_{2P}(t) by
calculating G_{1P}(t) by subtracting G_{2D}(t) from the impulse response G₁(t),
calculating G_{1Q}(t) by subtracting G_{2S}(t) from the impulse response G₁(t),
calculating G_{2Q}(t) by subtracting G_{1D}(t) from the impulse response G₂(t), and
calculating G_{2P}(t) by subtracting G_{1S}(t) from the impulse response G₂(t),
calculates, in a fifth step,
active intensity I_{P}(ω) and reactive intensity Q_{P}(ω) from G_{1P}(ω) and G_{2P}(ω), and
active intensity I_{Q}(ω) and reactive intensity Q_{Q}(ω) from G_{1Q}(ω) and G_{2Q}(ω), and
calculates, in a sixth step, a sound absorption coefficient α(ω) using the active intensity I_{P}(ω) and the active intensity I_{Q}(ω) by α(ω)=1−|I_{Q}(ω)/I_{P}(ω)|.

17. The acoustic diagnostic apparatus according to claim 16, wherein after the fourth step and before the fifth step, impulse response correction (frequency domain) is performed in accordance with
$$\frac{{G}_{1 P} ( ω )}{1 - {D}^{2} ( ω )} \to {G}_{1 P} ( ω ) \qquad ( 1 )$$
$$\frac{{G}_{1 Q} ( ω )}{1 - {S}^{2} ( ω )} \to {G}_{1 Q} ( ω )$$
$$\frac{{G}_{2 Q} ( ω )}{1 - {D}^{2} ( ω )} \to {G}_{2 Q} ( ω )$$
$$\frac{{G}_{2 P} ( ω )}{1 - {S}^{2} ( ω )} \to {G}_{2 P} ( ω )$$
$$D ( ω ) = exp ( - j ω \times {tap}_{shift} / {f}_{s} )$$
$$S ( ω ) = exp ( j ω \times {tap}_{shift} / {f}_{s} )$$
wherein “→” means that a transfer characteristic on a left side (before the arrow) is replaced by a transfer characteristic on a right side (after the arrow).

18. An acoustic diagnostic method comprising:
applying an acoustic vibration to a diagnosis target object by continuously inputting an acoustic vibration signal to an acoustic vibration unit;
calculating an impulse response based on a sound reception signal output from a sound receiving unit configured to receive an evaluation target sound including a sound wave reflected from the diagnosis target object and a vibration radiated sound from the diagnosis target object;
calculating an acoustic characteristic using the impulse response, and analyzing a state of the diagnosis target object by grasping a change of the sound reception signal; and
diagnosing the state of the diagnosis target object based on an analysis result.

19. A non-transitory computer-readable storage medium storing an acoustic diagnostic program for causing a computer, including a processor and a storage device, to
execute functions of an acoustic vibration signal generation unit, an impulse response calculation unit, a structure state analysis unit, and a structure state diagnostic unit, all of which are defined in claim 1.
